(19) United States
(12) Patent Application Publication
(10) Pub. No.: US 2007/0223658 A1
(43) Pub. Date: Sep. 27, 2007

(54) Method and Apparatus to Facilitate Deployment of One or More Private Civil Security Resources

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/566,455

(22) Filed: Dec. 4, 2006

Related U.S. Application Data
(63) Continuation-in-part of application No. 11/384,037, filed on Mar. 17, 2006.
(63) Continuation-in-part of application No. 11/394,350, filed on Mar. 30, 2006.
(63) Continuation-in-part of application No. 11/279,333, filed on Apr. 11, 2006.
(63) Continuation-in-part of application No. 11/379,929, filed on Apr. 24, 2006.
(63) Continuation-in-part of application No. 11/381,247, filed on May 2, 2006.
(63) Continuation-in-part of application No. 11/381,257, filed on May 2, 2006.
(63) Continuation-in-part of application No. 11/381,265, filed on May 2, 2006.
(63) Continuation-in-part of application No. 11/381,277, filed on May 2, 2006.
(63) Continuation-in-part of application No. 11/383,022, filed on May 12, 2006.
(63) Continuation-in-part of application No. 11/420,594, filed on May 26, 2006.
(63) Continuation-in-part of application No. 11/421,694, filed on Jun. 1, 2006.
(63) Continuation-in-part of application No. 11/423,594, filed on Jun. 12, 2006.
(63) Continuation-in-part of application No. 11/425,043, filed on Jun. 19, 2006.
(63) Continuation-in-part of application No. 11/426,231, filed on Jun. 23, 2006.
(63) Continuation-in-part of application No. 11/456,472, filed on Jul. 10, 2006.
(63) Continuation-in-part of application No. 11/461,605, filed on Aug. 1, 2006.
(63) Continuation-in-part of application No. 11/461,624, filed on Aug. 1, 2006.
(63) Continuation-in-part of application No. 11/462,795, filed on Aug. 7, 2006.
(63) Continuation-in-part of application No. 11/462,845, filed on Aug. 7, 2006.
(63) Continuation-in-part of application No. 11/464,751, filed on Aug. 15, 2006.
(63) Continuation-in-part of application No. 11/464,764, filed on Aug. 15, 2006.
(63) Continuation-in-part of application No. 11/464,775, filed on Aug. 15, 2006.
(63) Continuation-in-part of application No. 11/464,788, filed on Aug. 15, 2006.
(63) Continuation-in-part of application No. 11/464,799, filed on Aug. 15, 2006.
(63) Continuation-in-part of application No. 11/465,063, filed on Aug. 16, 2006.
(63) Continuation-in-part of application No. 11/466,727, filed on Aug. 23, 2006.
(63) Continuation-in-part of application No. 11/466,953, filed on Aug. 24, 2006.
(63) Continuation-in-part of application No. 11/470,156, filed on Sep. 5, 2006.
(63) Continuation-in-part of application No. 11/531,651, filed on Sep. 13, 2006.
(63) Continuation-in-part of application No. 11/532,461, filed on Sep. 15, 2006.
(63) Continuation-in-part of application No. 11/535,021, filed on Sep. 25, 2006.
(63) Continuation-in-part of application No. 11/535,282, filed on Sep. 26, 2006.
(63) Continuation-in-part of application No. 11/537,469, filed on Sep. 29, 2006.
(63) Continuation-in-part of application No. 11/539,798, filed on Oct. 9, 2006.
(63) Continuation-in-part of application No. 11/539,861, filed on Oct. 9, 2006.
(63) Continuation-in-part of application No. 11/548,191, filed on Oct. 10, 2006.
(63) Continuation-in-part of application No. 11/549,874, filed on Oct. 16, 2006.
(63) Continuation-in-part of application No. 11/550,594, filed on Oct. 18, 2006.
(63) Continuation-in-part of application No. 11/551,083, filed on Oct. 19, 2006.
(63) Continuation-in-part of application No. 11/554,452, filed on Oct. 30, 2006.
(63) Continuation-in-part of application No. 11/555,589, filed on Nov. 1, 2006.
(63) Continuation-in-part of application No. 11/555,896, filed on Nov. 2, 2006.
(63) Continuation-in-part of application No. 11/556,520, filed on Nov. 3, 2006.
(63) Continuation-in-part of application No. 11/559,278, filed on Nov. 13, 2006.
(60) Provisional application No. 60/820,628, filed on Jul. 28, 2006.
(60) Provisional application No. 60/823,806, filed on Aug. 29, 2006.
(60) Provisional application No. 60/825,524, filed on Sep. 13, 2006.
(60) Provisional application No. 60/825,976, filed on Sep. 18, 2006.
(60) Provisional application No. 60/826,491, filed on Sep. 21, 2006.
(60) Provisional application No. 60/827,591, filed on Sep. 29, 2006.
(60) Provisional application No. 60/827,820, filed on Oct. 2, 2006.
(60) Provisional application No. 60/827,828, filed on Oct. 2, 2006.
(60) Provisional application No. 60/828,341, filed on Oct. 5, 2006.
(60) Provisional application No. 60/828,342, filed on Oct. 5, 2006.
(60) Provisional application No. 60/829,447, filed on Oct. 13, 2006.
(60) Provisional application No. 60/829,779, filed on Oct. 17, 2006.
(60) Provisional application No. 60/862,398, filed on Oct. 20, 2006.
(60) Provisional application No. 60/862,718, filed on Oct. 24, 2006.
(60) Provisional application No. 60/863,469, filed on Oct. 30, 2006.
(60) Provisional application No. 60/863,481, filed on Oct. 30, 2006.
(60) Provisional application No. 60/864,302, filed on Nov. 3, 2006.

(51) Int. Cl. H04M 11/04

(52) U.S. Cl. 379/37

(57) ABSTRACT

Prior to an occurrence of an applicable civilly-catastrophic event, one provides (101) a memory (404) having information stored therein regarding authorized beneficiaries of consideration-based private civil security subscriptions that provide civilly-catastrophic event-based access to at least one private civil security resource (301). One then also provides (103) a processor (201) that is operably coupled to this memory and that is configured and arranged to facilitate deployment of the private civil security resource on behalf of at least one of the authorized beneficiaries in response to circumstances as correspond to a civilly-catastrophic event. A processor interface (401) can then be provided (102) that operably couples to this processor to further assist with such facilitation.

### RELATED APPLICATIONS

This application claims the benefit of the filing date of U.S. provisional application Nos. 60/820,628 filed on Jul. 28, 2006, 60/823,806 filed on Aug. 29, 2006, 60/825,524 filed on Sep. 13, 2006, 60/825,976 filed on Sep. 18, 2006, 60/826,491 filed on Sep. 29, 2006, 60/827,591 filed on Sep. 29, 2006, 60/827,820 filed on Oct. 2, 2006, 60/827,828 filed on Oct. 2, 2006, 60/828,341 filed on Oct. 5, 2006, 60/828,342 filed on Oct. 5, 2006, 60/829,447 filed on Oct. 13, 2006, 60/829,779 filed on Oct. 17, 2006, 60/862,398 filed on Oct. 20, 2006, 60/862,718 filed on Oct. 24, 2006, 60/863,469 filed on Oct. 30, 2006, 60/863,481 filed on Oct. 30, 2006, 60/864,302 filed on Nov. 3, 2006, which are hereby incorporated in their entirety herein.

This comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

SUBSCRIPTION-BASED MOBILE SHELTER METHOD as filed on Sep. 5, 2006 and having application Ser. No. 11/470,156;

METHOD OF PROVIDING A FLOATING LIFE-SUSTAINING FACILITY as filed on Sep. 13, 2006 and having application Ser. No. 11/531,651;

PRIVATELY PROVISIONED SUB-UNIT-BASED SURVIVAL SUPPLIES PROVISIONING METHOD as filed on Sep. 15, 2006 and having application Ser. No. 11/532,461;

PRIVATELY PROVISIONED INTERLOCKING SUB-UNIT-BASED SURVIVAL SUPPLIES PROVISIONING METHOD as filed on Sep. 25, 2006 and having application Ser. No. 11/535,021;

RESOURCE CONTAINER AND POSITIONING METHOD AND APPARATUS as filed on Sep. 26, 2006 and having application Ser. No. 11/535,282;

PUBLICLY-FUNDED PRIVATELY FACILITATED ACCESS TO SURVIVAL RESOURCES METHOD as filed on Sep. 29, 2006 and having application Ser. No. 11/537,469;

ELECTRICITY PROVIDING PRIVATELY PROVISIONED SUBSCRIPTION-BASED SURVIVAL SUPPLY UNIT METHOD AND APPARATUS as filed on Oct. 9, 2006 and having application Ser. No. 11/539,798;

PREMIUM-BASED CIVILLY-CATASTROPHIC EVENT THREAT ASSESSMENT as filed on Oct. 9, 2006 and having application Ser. No. 11/539,861;

PRIVATELY MANAGED ENTERTAINMENT AND RECREATION SUPPLIES PROVISIONING METHOD as filed on Oct. 10, 2006 and having application Ser. No. 11/548,191;

METHOD TO FACILITATE PROVIDING ACCESS TO A PLURALITY OF PRIVATE CIVIL SECURITY RESOURCE as filed on Oct. 16, 2006 and having application Ser. No. 11/549,874;

METHOD OF PROVIDING BEARER CERTIFICATES FOR PRIVATE CIVIL SECURITY BENEFITS as filed on Oct. 18, 2006 and having application Ser. No. 11/550,594;

METHOD FOR CIVILLY-CATASTROPHIC EVENT-BASED TRANSPORT SERVICE AND VEHICLES THEREFOR as filed on Oct. 19, 2006 and having application Ser. No. 11/551,083;

METHOD FOR PROVIDING PRIVATE CIVIL SECURITY SERVICES BUNDLED WITH SECOND PARTY PRODUCTS as filed on Oct. 30, 2006 and having application Ser. No. 11/554,452;

SYSTEM AND METHOD FOR A PRIVATE CIVIL SECURITY LOYALTY REWARD PROGRAM as filed on Nov. 1, 2006 and having application Ser. No. 11/555,589;

SUBSCRIPTION BASED SHUTTLE METHOD as filed on Nov. 2, 2006 and having application Ser. No. 11/555,896;

METHOD AND SECURITY MODULES FOR AN INCIDENT DEPLOYMENT AND RESPONSE SYSTEM FOR FACILITATING ACCESS TO PRIVATE CIVIL SECURITY RESOURCES as filed on Nov. 3, 2006 and having application Ser. No. 11/556,520; and

METHOD OF PROVIDING SURVIVAL SUPPLIES CONTAINER WITH AN ILLUMINATION APPARATUS as filed on Nov. 13, 2006 and having application Ser. NO. 11/559,278; the contents of each of which are fully incorporated herein by this reference.

### TECHNICAL FIELD

This invention relates generally to providing private civil security benefits.

### BACKGROUND

Many citizens of the world have long passed the point when a ready availability of the basic necessities of life is satisfactory in and of itself. Today's consumer-oriented citizens demand, and often receive, an incredibly diverse and seemingly ever-growing cornucopia of consuming and experiential options. Such riches are typically based, in turn, upon a highly interdependent series of foundational infrastructure elements. Examples of the latter include, but are certainly not limited to:

transportation infrastructure such as roads, bridges, railways, and so forth that facilitate the inexpensive and rapid movement of sometimes perishable goods from source to consumer;

communications infrastructure such as telephones, television, radio, and the Internet that facilitate the inexpensive and rapid sharing of news, advice, information, and entertainment; and

the totality of civil services such as police services, fire fighting services, medical services, and so forth that facilitate a sufficient degree of order and predictability to, in turn, permit the complex series of inter-related interactions that modern society requires in order to operate.

As powerful as the machinery of modern life appears, however, modern citizens are today perhaps more at risk of experiencing a serious disruption in their ability to prosper or even to survive en mass than is generally perceived. Providing the necessities of life in general requires a lot of things to all operate, more or less, correctly. To put it another way, a serious disruption to any significant element of civilized infrastructure can produce catastrophic results for a broad swatch of a given civil community. Any number of natural and/or non-naturally-caused events can sufficiently disrupt society's infrastructure and ability to provide one or more life-sustaining resources such as hydration, nutrition, shelter, and the like.

Many people believe and trust that their government (local, regional, and/or national) will provide for them in the event of such a civilly-catastrophic event. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a civilly-catastrophic event occurs.

Such insights, of course, are not particularly new. Civil preparedness shortcomings occasionally attract public attention and niche marketing opportunities exist with respect to provisioning the needs of so-called survivalists. Indeed, there are those who spend a considerable amount of their time and monetary resources attempting to ready themselves to personally survive a civilly-catastrophic event. Therein, however, lies something of a conundrum.

On the one hand, modern governments typically do little to proactively ensure the bulk survival (let alone the comfort) of their citizens in the face of most civilly-catastrophic events. On the other hand, attempting to take responsible actions to reasonably ensure one's own safety and security can become, in and of itself, nearly a full-time avocation and leave little time to actually enjoy the conveniences and opportunities of modern life. Such individual actions may even be frowned upon by the greater part of society which has grown accustomed and falsely secure with existing efficient just-in-time delivery systems that provide the illusion of plenty while undercutting the perception of risk.

As a result, many (if not most) individuals and their families are largely bereft of access to survival resources that they will need should a civilly-catastrophic event befall them. This shortcoming tends to be relatively comprehensive; most people have ready access to neither a sufficient selection of survival supplies nor a sufficient quantity. For people who do have a store of supplies set aside against such an eventuality, it can be a considerable burden to maintain and ensure the freshness, vitality, and usability of those supplies. At the same time, the same civilly-catastrophic event that occasions their need for supplies will also likely disrupt relevant supply chains enough to cause a partial or complete shortage of supplies at their local merchants. The unfortunate net result is a relatively near term severe need for a variety of survival supplies that will often go unmet for lengthy periods of time.

Such persons are also largely without many options when faced with civilly-catastrophic conditions that create a concurrent need for shelter, evacuation, and/or rescue. For example, in many cases, the only available shelter comprises a public facility such as a school, auditorium, or sports venue on the one hand or ad hoc accommodations obtained at a hotel or via a charity or one's own social network. In some cases, such options may be adequate. In many other cases, however, such options quickly prove inadequate or even dangerous in and of themselves. Even in cases where public civil security resources in the aggregate may be adequate, significant problems can arise with respect to properly deploying such resources to ensure that needed resources are provided to those in need while simultaneously avoiding waste, confusion, or unnecessary loss.

### BRIEF DESCRIPTION OF THE DRAWINGS

The above needs are at least partially met through provision of the method and apparatus to facilitate deployment of one or more private civil security resources described in the following detailed description, particularly when studied in conjunction with the drawings, wherein:

FIG. 1 comprises a flow diagram as configured in accordance with various embodiments of the invention;

FIG. 2 comprises a schematic block diagram view as configured in accordance with various embodiments of the invention;

FIG. 3 comprises a schematic block diagram as configured in accordance with various embodiments of the invention;

FIG. 4 comprises a schematic block diagram as configured in accordance with various embodiments of the invention; and

FIG. 5 comprises a schematic block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments and prior to an occurrence of an applicable civilly-catastrophic event, one provides a memory having information stored therein regarding authorized beneficiaries of consideration-based private civil security subscriptions that provide civilly-catastrophic event-based access to at least one private civil security resource. One then also provides a processor that is operably coupled to this memory and that is configured and arranged to use this information to facilitate deployment of the private civil security resource on behalf of at least one of the authorized beneficiaries in response to circumstances as correspond to a civilly-catastrophic event. A processor interface can then be provided that operably couples to this processor to further assist with such facilitation.

By one approach, a plurality of such processor interfaces can be so provided. Such processor interfaces can comprise, by one approach, a user interface to thereby facilitate the provision of information and/or queries to the processor and/or the provision of information (such as deployment recommendations or instructions) from the processor to a corresponding user. So configured, a relatively large number of private civil security personnel can be coordinated and instructed with respect to their respective actions or inaction. Such processor interfaces can also comprise, if desired, an automaton interface to thereby facilitate automated responses to the deployment strategies of the processor.

If desired, such a processor can further base its private civil security deployment processing upon additional information. Examples in this regard include, but are not limited to, information regarding a given civilly-catastrophic event (including, for example, classification information regarding this particular event) as well as a variety of information regarding various factors that can relate to the ease, or lack of ease, by which such deployment actions can be successfully carried out.

So configured, the deployment of various private civil security resources (including, for example, any of private civil security provisions, private civil security facilities, and/or private civil security services) can be rationally and quickly effected under the most trying of circumstances. This, in turn, can aid with avoiding delays, confusion, and/or errors that might otherwise arise due to human cognitive overloading during a civilly-catastrophic event-based time of need. As a result, the authorized beneficiaries of such benefits are more concretely assured of a timely, effective, and tangible delivery of necessary and expected private civil service benefits notwithstanding trying circumstances that might otherwise materially disrupt such a concrete result.

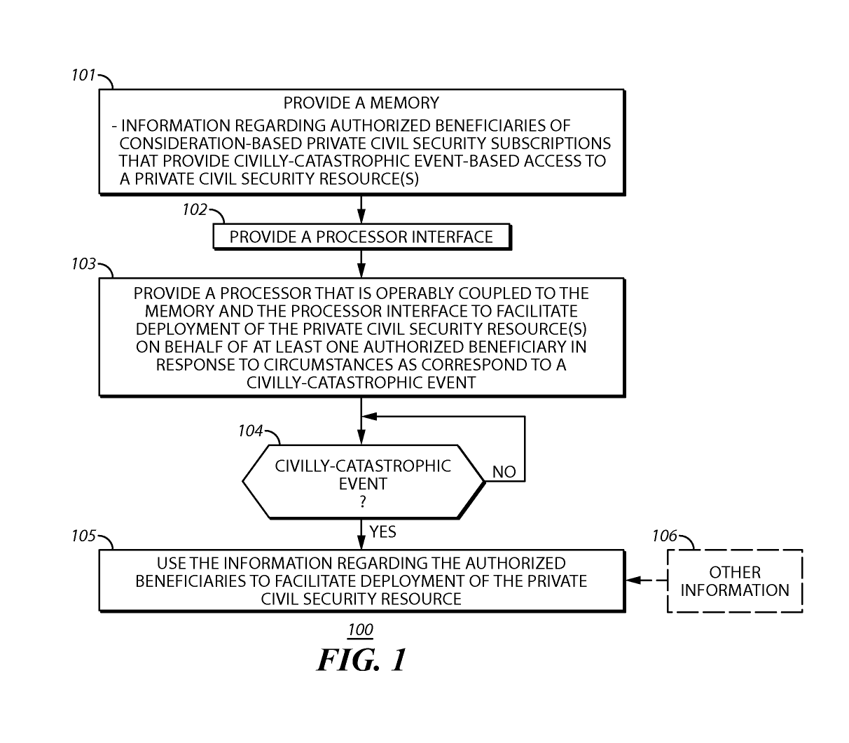

These and other benefits may become clearer upon making a thorough review and study of the following detailed description. Referring now to the drawings, and in particular to FIG. 1, a corresponding process 100 provides, prior to an occurrence of an applicable civilly-catastrophic event, a memory having information stored therein regarding authorized beneficiaries of consideration-based private civil security subscriptions that provide civilly-catastrophic event-based access to at least one private civil security resource.

As used herein, “private” will be understood to refer to the opposite of public ownership or control (as exemplified by governmental or ecclesiastical ownership or control) but can include such things as ownership or control via publicly traded ownership (via, for example, publicly traded stock or the like), ownership or control via a not-for-profit entity, or the like. By one approach, these subscriptions may be accepted by, for example, a for-profit business. By another approach a not-for-profit business (such as a membership-based-entity) may be the appropriate entity to offer and accept such subscriptions.

As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers month-by-month payments to gain corresponding month-by-month access rights);

rights of access predicated upon a one-time payment (as may occur when a subscriber makes a single payment to obtain a time-based or event-based duration of access rights or, if desired, when a single payment serves to acquire a one-time-only right of access or a perpetual right of access that may be retained, transferred, inherited, or the like);

ownership-based rights of access (as may occur when the subscription provides for ownership rights with respect to the civil security resources, when the subscription is based upon shareholder-based ownership of the provider of such civil security resources, or the like);

non-transferable rights of access (as may occur when the subscription, by its terms and conditions, prohibits transfer of the right of access to the civil security resources from a first named beneficiary to another);

transferable rights of access (as may occur when the subscription, by its terms and conditions, permits conditional or unconditional transfer of the right of access from a first named beneficiary to another);

membership-based rights of access (as may occur when the subscription, by its terms and conditions, establishes a membership interest with respect to the accorded right of access such as, for example, a club-based membership); fractionally-based rights of access (as may occur when the subscription, by its terms and conditions, establishes a divided interest by and between multiple subscription beneficiaries with respect to a right to access the civil security resources);

non-ownership based rights of access (as may occur when the subscription, by its terms and conditions, establishes the aforementioned right of access via, for example, a lease, a rental, or borrowing construct);

option-based rights of access (as may occur when the subscription, by its terms and conditions, establishes a right for an authorized beneficiary to later obtain access to some or all such civil security resources upon, for example, paying an additional supplemental amount at that time);

credit-based rights of access (as may occur when a given individual predicates their right to access the civil security resources upon a representation, promise, or other credit-based transaction); and

group-based rights of access (as may occur when a given subscription requires that the authorized beneficiary belong to a particular group such as, for example, a particular club or organization, the employees of a particular enterprise, or the residents of a particular area (such as a metropolitan area, a county, a state, a country, or the like);

to note but a few examples in this regard.

As used herein, “civilly-catastrophic event” will be understood to refer to an event that substantially and materially disrupts a society's local, regional, and/or national infrastructure and ability to provide in ordinary course for at least one life-sustaining resource. Such a civilly-catastrophic event can include both a precipitating event (which may occur over a relatively compressed period of time or which may draw out over an extended period of time) as well as the resultant aftermath of consequences wherein the precipitating event and/or the resultant aftermath include both the cause of the infrastructure interruption as well as the continuation (or worsening) of that interruption.

A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based events (such as collisions with comets, large asteroids, and so forth, extreme solar flares, and the like), extreme environmental events (such as widespread uncontrolled fire or the like), and global or regional pandemics, to note but a few.

Examples of non-naturally-caused disasters capable of initiating a civilly-catastrophic event include both unintended events as well as intentional acts of aggression such as war, terrorism, madness, or the like. Examples of non-naturally-caused disasters capable of such potential scale include, but are not limited to, nuclear-related events (including uncontrolled fission or fusion releases, radiation exposure, and so forth), acts of war, the release of deadly or otherwise disruptive biological or chemical agents or creations, exposure to a harmful mutagenic influence, and so forth.

By one approach, such access can be provided at the whim and convenience of the authorized beneficiaries. If desired, however, such access can be further conditioned in appropriate ways. For example, for many purposes and certainly as pertains to many of the civil security resources it may by appropriate to ordinarily limit such access to situations where such access is triggered, at least in part, by a civilly-catastrophic event having occurred or being likely imminent. Such access may be predicated, if desired, upon a requirement that the civilly-catastrophic event be one that persists in substantial form for more than a predetermined period of time (such as one hour, one day, one week, and so forth) or that causes at least a predetermined amount or degree of infrastructure impairment or other measurable impact of choice (such as a particular level or degree of harm, interference, or negative impact upon a given minimum number of people). In addition, or in lieu thereof, such access may be predicated, if desired, upon a requirement of a particular level of objectivity or subjectively ascertained likelihood that a particular category or kind of civilly-catastrophic event will occur within a particular period of time.

If desired, information regarding the authorized beneficiaries of a plurality of differentiated subscription opportunities may be included in this regard. This plurality of differentiated subscription opportunities can correspond, for example, to providing access to differing selections and/or quantities of the civil security resources. As but one very simple illustration in this regard, such subscription opportunities can differ from one another at least with respect to cost. This, in turn, provides subscriber choice with respect to selecting a particular subscription that best meets their specific needs and/or budget limitations.

As will be shown below, information regarding how a given authorized beneficiary may likely behave during a variety of civil security challenges may be available in some cases. In such a case, it would also be possible to vary the amount of consideration required to provide such a subscription to such an authorized beneficiary and/or to vary the type of civil security benefits/resources that are offered to such an authorized beneficiary. Generally speaking, relatively reduced amounts of consideration may be required for (or a relatively wider range of civil security resources offered to) authorized beneficiaries who appear to comprise relatively trouble-free (or even helpful) participants in a civil security activity while relatively higher amounts of consideration may be required for (or certain civil security resources denied to) authorized beneficiaries who appear to represent a greater challenge in these regards.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

The stored information can comprise any of a wide variety of content as pertains to the authorized beneficiaries. A non-exhaustive listing of possibly relevant examples might include (but not be limited to) information regarding one or more of:
an authorized beneficiary's identity (including, for example, their name, their nicknames or other aliases, and so forth);
personal information regarding the authorized beneficiary (including, for example, their birth date and age, nationality, citizenship, official residency status, gender, height, weight, race, religion, language fluency, and so forth);
medical information regarding the authorized beneficiary (including, for example, their medical history, vaccination history, physical and/or mental disabilities or impairments, mobility limitations and requirements, therapeutic and/or medicinal requirements, nutritional requirements and preferences, implanted devices, allergies and sensitivities, personality assessments, and so forth);
family information (including the identity and personal information for immediate family members, which may comprise, when such family members also comprise authorized beneficiaries, pointers or links to such information as may be stored elsewhere in the memory);
subscription information (regarding, for example, the terms, conditions, options, requirements, opportunities, and limitations of the authorized beneficiary's particular rights to access particular kinds and quantities of the private civil security resources);
scheduled behavior and locations (regarding, for example, the usually scheduled events and activities (such as work, school, meetings, sporting activities, fitness activities, and so forth) that the authorized beneficiary generally observes and/or where the authorized beneficiary is ordinarily located at corresponding times/days);
present (or recent) location of the authorized beneficiary as may be determined, for example, by providing the authorized beneficiary with a carriable device to determine the authorized beneficiary's location (using, for example, global position system signals when available) and to transmit that location information (directly or indirectly) to the provider of civil security benefits;
contact information (regarding, for example, various ways by which one or two-way communications with the authorized beneficiary can be carried out, such as but not limited to telephone numbers, email addresses, particular radio frequencies, encryption keys, and so forth);
a current level of shelter availability as pertains to the authorized beneficiaries (regarding, for example, shelter facilities as are owned, possessed, or controlled by the authorized beneficiary or to which the authorized beneficiary has ready access);
a current level of provisioning as pertains to the authorized beneficiaries (as when such authorized beneficiaries have readily available to them civil security provisions, either locally (as when such civil security provisions are stored at the authorized beneficiary's residence, in a storage facility that is proximal to an authorized beneficiary's residence (such as, for example, within one mile or some other distance of choice), in a pre-provisioned trailer that is stored at an available and accessible facility on behalf of the authorized beneficiary, and so forth);
experience and skills information (regarding, for example, a record of civil security training that the authorized beneficiary has undertaken, civil security experiences, particular skills or experience of interest (such as carpentry skills, martial arts training, military training, or the like), and so forth);
suggestions regarding how the authorized beneficiary will tend to behave during a civilly-catastrophic event (for example, information that tends to suggest how the individual will behave with respect to at least one of a civil security shelter environment, civil security transportation, participation in a civil security rescue activity, civil security-related tasks, cooperation with others in a civil security activity, and so forth);
affiliation of a given authorized beneficiary with an affinity group that shares a common interest in civil security behaviors, tactics, strategies, practices, and so forth (and which hence serves to suggest that this authorized beneficiary will likely comprise more than merely a passive recipient and consumer of civil security resources);
status of the authorized beneficiary as personnel, or a relative of personnel, of the provider of civil security benefits;
status of the authorized beneficiary as comprising, or being an immediate or distant relative of, an emergency first responder (which information can be highly relevant when the provider of civil security benefits has undertaken to provide such persons and/or their immediate or distant family members with discounted or free civil security benefits to encourage such persons to remain at their posts during a given civilly-catastrophic event); and/or
one or more assessments regarding the authorized beneficiary as may be developed, for example, by the provider of civil security benefits and/or an agent thereof (where such assessments may comprise, if desired, a characterizing metric, rating, or the like regarding opinions and/or categorizations regarding the authorized beneficiary);
   to note but a few examples in this regard.

Such information regarding the authorized beneficiary can be obtained in a single data-gathering activity/event or over time and pursuant to any number of data collection opportunities. This can also include updating such information from time to time and/or as appropriate to reflect changing circumstances, preferences, and new, additional information.

Such information may be secured and protected as desired to limit access to and/or the use of such information to thereby protect the privacy and identity of the authorized beneficiaries. This can comprise, for example, storing such information in a physically protected facility that employs physical and procedural barriers, storing such information in one or more backup or redundant storage platforms/facilities to assure the persistence and availability of such information, the use of controlled and/or auditable access techniques and protocols, data isolation platforms and procedures (including but not limited to read and write access controls), encryption, and so forth. By one approach, such information can be effectively retained in a manner that largely (or completely) precludes access or viewing by any persons. By another approach, such information, at least in part, can be rendered available to at least a limited class of personnel who have a mission-related need-to-know during a civilly-catastrophic event-based time of need.

This process 100 then provides for providing 102 a processor interface. This processor interface can assume any of a wide variety of interfaces, including both human and automaton interfaces. Further discussion regarding such a processor interface appears below where relevant.

This process 100 then provides 103 a processor that is operably coupled to both the memory and the processor interface. This processor is configured and arranged to facilitate deployment of the aforementioned private civil security resource on behalf of at least one of the authorized beneficiaries in response to circumstances as correspond to a civilly-catastrophic event. Further elaboration in this regard will also be presented further below.

Upon detecting 104 an occurrence of a civilly-catastrophic event (which may comprise detecting the event itself by direct or indirect indicia or may comprise determining the existence of a clear and present imminent likelihood that the event will so occur), this process 100 then provides for using 105 the information from the memory regarding the authorized beneficiaries to facilitate deployment of the private civil security resource on behalf of the authorized beneficiaries in response to circumstances as correspond to the civilly-catastrophic event. Such facilitation can assume any of a number of substantive and/or procedural forms.

As one example in this regard, such facilitation can comprise, at least in part, selecting a particular authorized beneficiary contact protocol (from a plurality of candidate authorized beneficiary contact protocols) to employ with respect to deploying the private civil security resource. To illustrate, the private civil security resource may comprise private civil security provisions that are to be delivered to the particular authorized beneficiary during a civilly-catastrophic event-based time of need. One candidate protocol might provide, for example, for such a delivery to occur within a particular time frame regardless of whether the provider of civil security benefits has established any contact with this authorized beneficiary to determine whether such a delivery should, in fact, proceed. Another candidate protocol might provide, instead, for such a delivery to only proceed following receipt of specific instructions from the authorized beneficiary that the civil security provisions are to be delivered.

As another illustrative example in this regard, when the aforementioned information regarding the authorized beneficiary comprises information regarding a right, via a given one of the consideration-based private civil security subscriptions, to optionally acquire emergency supplies (such as, but not limited to, building materials, barrier creation materials, and/or additional civil security provisions of one sort or another) in the event of a given recognized civilly-catastrophic event having occurred or, optionally, being imminently likely, such facilitation can comprise, at least in part, facilitating an interactive order-taking process, preparing a staging area from which such emergency supplies can be delivered, sending project specialists to the field to assist such authorized beneficiaries with estimating the emergency supplies that they should or could be acquiring, and so forth, This can further comprise, if desired, providing for optional access to temporarily renting, leasing, or otherwise having and using construction tools and equipment (such as hand tools, power tools, scaffolding, ladders, hoists, earthmovers, and the like).

By one approach, the use of such information can be further supplemented with other information 106. In particular, the aforementioned facilitation of civil security resource deployment can be further conducted, at least in part, as a function of information regarding at least one of:
a characterizing nature of the civilly-catastrophic event itself (regarding, for example, the suddenness by which the event may occur, the likely duration of the event, the intensity of the event, and so forth);
a geographic location of an area that is at least likely to be impacted by the civilly-catastrophic event (regarding, for example, the urban or non-urban nature of the setting and so forth);
the terrain of an area that is at least likely to be impacted by the civilly-catastrophic event (regarding, for example, such things as the presence of relatively flat terrain, hilly terrain, mountainous terrain, bodies of water, and so forth);
applicable information regarding the particular authorized beneficiary (regarding, for example, such things as a present location of the authorized beneficiary, a scheduled future location of the authorized beneficiary, and so forth);
a likely number of persons to be substantially directly affected by the civilly-catastrophic event;
a corresponding season as pertains to an area that is at least likely to be impacted by the civilly-catastrophic event (reflecting, for example, a presence or absence of particular seasonal influences relating to temperature, precipitation, prevailing winds and currents, humidity, availability of daylight hours, and so forth);
weather as pertains to an area that is at least likely to be impacted by the civilly-catastrophic event (as relates to present or predicted weather conditions such as temperature, humidity, cloud cover and visibility, wind, precipitation, fog, and storm conditions of various kinds, to note but a few examples in this regard);
prevailing ambient lighting as pertains to an area that is at least likely to be impacted by the civilly-catastrophic event (as relates, for example, to both natural light sources such as the sun or a full moon as well as other light sources such as electric lighting, fire, and so forth);
a particular weekly day as pertains to an area that is at least likely to be impacted by the civilly-catastrophic event (to distinguish, for example, a weekday from a weekend day, a holiday from a non-holiday, and so forth);
a particular time of day as pertains to an area that is at least likely to be impacted by the civilly-catastrophic event;
potential obstacles to private civil security resources service providers as pertains to an area that is likely to be impacted by the civilly-catastrophic event (such as vehicular obstacles such as impaired roadways and other thoroughfares, unpoliced lawless individuals and groups, an absence of particular elements of civil infrastructure such as electricity, flooded conditions, a substantial lack of civil order, terrain-based obstacles, visual impairment-based obstacles, dangerous air-borne contaminants, a zone of dangerous ionizing radiation, and so forth);
residual threats to private civil security resources service providers as pertains to an area that is likely to be impacted by the civilly-catastrophic event (for example, any of a variety of environmentally-borne threats such as ionizing radiation, dangerous chemical and/or biological agents, dangerous mutagenic influences, and so forth);
demographic information, historical information, and/or real-time information regarding the inhabitants of an area within which the civil security benefits provider's personnel may need to operate (which information may provide direct or indirect suggestions regarding the likelihood of such inhabitants to inhibit, interfere with, or otherwise obstruct such personnel and/or the authorized beneficiaries);
an ability to communicate with the particular authorized beneficiary notwithstanding the civilly-catastrophic event (such as an ability or absence of
an ability to contact the authorized beneficiary using public or private lines of communication; and/or
a likely duration of a debilitating influence of the civilly-catastrophic event (which can encompass both the civilly-catastrophic event itself as well as the consequences and circumstances of the aftermath of such an event);
   to note but a few examples in this regard.

Such other information can be provided from any of a wide variety of sources. These sources can be public or private and can even derive, if desired, from sensors and other monitors as are carried by or installed with the permission and acquiescence of one or more of the authorized beneficiaries. Such sensors/monitors can comprise real-time or near-real time data accumulators, if desired, and can provide their content on a real-time and/or occasional batched basis. The information captured and reflected in this way can vary with the technology employed. Examples in this regard can include, but are not limited to:
live video and/or audio feeds (of, for example, roadways, waterways, landing strips and landing pads, sidewalks, buildings (including residences, schools, government buildings, office buildings, retail and commercial properties, industrial areas, power generation facilities, communication centers, medical centers, police stations, military establishments, penal institutions, and so forth);
telemetry regarding the movement of objects of interest;
information regarding airborne hazards of various types;
bright flashes of light;
concussive events;
biological monitors (such as the pulse, blood pressure, body temperature, or the like of one or more monitored individuals;
   and so forth, to note but a few. By one approach, it would also be possible to garner at least some such information from a variety of networked automatons. This could comprise, for example, including data collection and forwarding software agents in special purpose and/or relatively ubiquitous software platforms (such as operating systems and popular programs such as word processing programs and the like) that are configured and arranged to detect and mine locally available information of interest and automatically forward such information to the attention of the aforementioned processor. Such locally available information could comprise, for example, webcam inputs, sensor inputs of various kinds (such as weather sensors, temperature sensors, and so forth), responses by local users to queries as are sourced and presented by the agent software (such as, for example, “Are you experiencing a seismic event at this time,” “Did you, within the last few minutes, see a very bright flash in the sky,” or the like), and so forth.

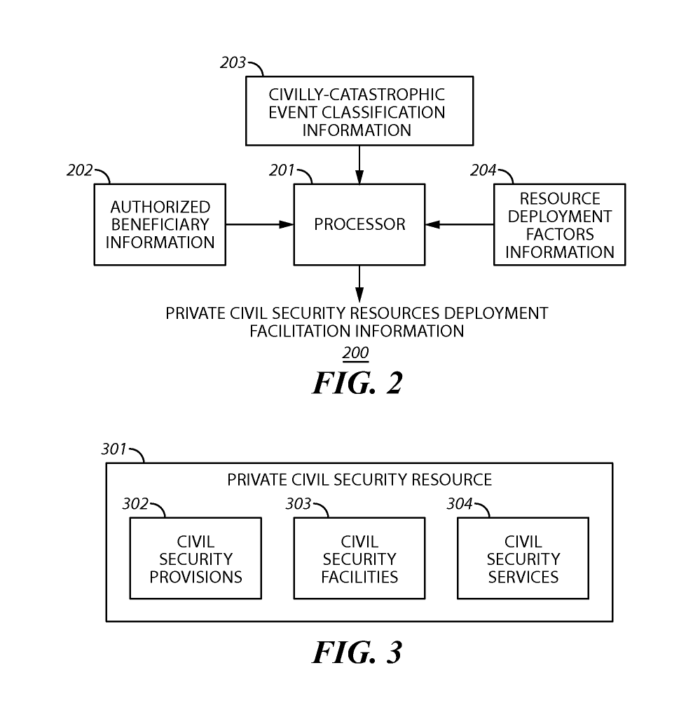

By one approach, then, and referring now to FIG. 2, such a processor 201 can be configured and arranged to form and output private civil security resources deployment facilitation information in response to authorized beneficiary information 202, civilly-catastrophic event classification information 203, and/or resource deployment factors information 204 such as that presented above. So configured, such deployment facilitation information can be generally, specifically, and even personally informed to better ensure that the civil security resources are optimally deployed to meet the anticipated and/or actual needs of the authorized beneficiaries when responding to a civilly-catastrophic event and its aftermath of consequences and challenges. This can comprise tending to ensure that such resources are neither needlessly deployed nor unavailable where and when needed.

As one illustrative example in this regard, the stored specific information regarding a given authorized beneficiary might, in a given instance, reveal that this particular authorized beneficiary has a shelter in their home basement. This information can further comprise specific information that characterizes the nature of the shelter with respect to its structural integrity, its size, its appropriateness for various kinds and categories of civilly-catastrophic events, and so forth (for example, such information might reveal that the shelter has a relatively high degree of structural integrity but lacks an ability to protect an inhabitant from airborne threats such as dangerous gases). When the other information, such as information regarding the nature of a given civilly-catastrophic event, reveals that the inability of this shelter to protect its inhabitants from airborne threats represents an immediate danger to the authorized beneficiary, such deployment facilitation can comprise immediately effecting deployment of a rescue effort to extract the authorized beneficiary from exposure to the civilly-catastrophic event-based threat. Similarly, when the information regarding the nature of the civilly-catastrophic event reveals that the authorized beneficiary's shelter is sufficient to protect the authorized beneficiary, an unnecessary rescue deployment can be avoided.

Those skilled in the art will understand and appreciate that these teachings are readily applied in conjunction with the deployment of a wide variety of civil security resources. With reference to FIG. 3, such private civil security resources 301 can vary to some degree with respect to category and kind of resource. By one approach, however, such resources 301 can comprise, at least in part, civil security provisions 302, civil security facilities 303, and civil security services 304.

Generally speaking, both the civil security provisions 302 and the civil security facilities 303 are physical components rather than virtual or products of the intellect. For example, the civil security provisions 302 will typically comprise physical support and/or protection of one kind or another. Similarly, the civil security facilities 303 will also typically comprise physical assets such as, but not limited to, physical civil security shelters that provide real, substantive physical protection from physical threats to human life. The civil security services 304, however, can comprise either physical, real world services or virtual services.

The private civil security provisions 302 can comprise, for example, a plurality of life-sustaining resources as pertain to a plurality of differing categories of life's necessities. Examples in this regard include, but are not limited to, such elemental staples as water (which can comprise water in a pure or impure state and/or other water-based palatable fluids), food (which can comprise a wide variety of raw to highly processed food, nutritional supplements, and so forth), and protective clothing (where “protective” will be understood to refer to protection against one or more potentially hazardous environmental influences such as temperature extremes, precipitation, high velocity winds, and the like but not to matters of fashion, social comment, or the like). These civil security provisions 302 can further optionally include such components as breathable air (which may comprise, for example, a fresh air supply, an oxygen supply that can serve as a source of oxygen to mix with other atmospheric components, and/or personal or area air filters that serve to remove harmful airborne contaminants from the air prior to being inhaled by an authorized beneficiary), deployable shelters (where “deployable” will be understood as referring to portable shelters such as tents, canopies, inflatable structures, and the like), and other items as may be appropriate to meet the needs of a given application setting.

By one approach, these civil security provisions 302 can be provided in a pre-deployment aggregated form. Such might be the case, for example, when accumulating such material at a warehouse or the like. These teachings will also accommodate, however, forming such civil security provisions 302 into corresponding units of civil security provisions. To illustrate, one such unit of civil security provisions as intended, for example, for a single authorized beneficiary might comprise, at least in part, consumable fluids, food, medical supplies, personal hygiene supplies, and environmental threat abatement supplies (such as, for example, breathing masks, so-called haz-mat garb, and the like). Such a unit of civil security provisions might comprise, for example, a short term unit that comprises a quantity and variety of civil security supplies that are adequate to sustain life for that one authorized beneficiary for, say, at least three days and no more than, say, about fifteen days. As another illustrative example, such a unit of civil security provisions might comprise a longer term unit that comprises a quantity and variety of civil security supplies that are adequate to sustain life for that authorized beneficiary for, say, at least about thirty days but no more than, say, about one year.

Those skilled in the art will recognize and understand that there are various ways by which such adequacy can be determined, measured, and/or established. For example, by one approach, the adequacy of any food contents can be determined as a function of a particular target caloric intake per person on a per day basis. Similarly, the adequacy of any consumable fluid contents could be determined as a function of a particular target quantity intake per person on a per day basis.

The particular time frames suggested in the above examples are intended only to serve an illustrative purpose and are not to be construed as limitations with respect to the practice of these teachings. Those skilled in the art will also appreciate and understand that such a unit of civil security provisions can comprise a quantity of supplies that are intended to support more than one authorized beneficiary for the given period(s) of time. For example, such a unit might comprise a family unit that contains sufficient contents to adequately sustain life for a family of four authorized beneficiaries.

These teachings will also accommodate providing civil security provisions 302 that differ from one another in ways other than by category or kind. For example, both branded and generic versions (or other differentiators with respect to quality) of a same kind of item can be provided if desired. It is also possible for non-survival related items, such as various luxury items, to also be included for provision to certain authorized beneficiaries.

The civil security facilities 303 can comprise various facilities as have application with respect to protecting such authorized beneficiaries from the effects (including the aftermath, if any) of a civilly-catastrophic event. These civil security facilities 303 will typically comprise physical assets that tend, categorically, to comprise part of a private civil security infrastructure. Such civil security facilities 303 can therefore comprise, for example:
one or more civil security shelters;
one or more rally points (at which authorized beneficiaries can gather in response to a civilly-catastrophic event in order to receive certain civil security services 304 such as transportation to another civil security facility 303 such as a shelter or at least to a location that is away from a location that presently (or imminently) lacks civil security (due, for example, to a civilly-catastrophic event, its aftermath, or both));
a location where at least some of the authorized beneficiary's civil security provisions 302 are available (such as a metropolitan, local, regional, and/or national distribution facility);
a trans-shipment facility for at least some of the civil security provisions 302 (where, for example, dis-aggregated provisions are brought and then parsed and aggregated into corresponding units of provisions destined for particular recipient authorized beneficiaries);
a medical services facility;
   and so forth, to note but a few relevant examples in this regard.

These teachings will readily accommodate a wide variety of civil security shelters. For example, such civil security facilities 303 can comprise both temporary civil security shelters and long term civil security shelters. A temporary civil security shelter will be understood to comprise a shelter that is configured and arranged to adequately shelter and sustain human life for a relatively short period of time. For example, such a temporary shelter might prove sufficient in this regard for, say, no more than about ten inhabitants for no more than about one week, ten days, 15 days, and the like. Generally speaking, a temporary shelter such as this is designed and intended to only serve as a temporary refuge from the effects of a civilly-catastrophic event. Should longer term accommodations be necessary in a given instance, the inhabitants of such a temporary shelter will often be better served to move to a long term civil security shelter.

A long term civil security shelter will be understood to comprise a shelter that is configured and arranged to adequately shelter and sustain human life for a relatively longer period of time. For example, such a temporary shelter might provide sufficient in this regard for, say, no more than about 100 inhabitants for up to about three months, six months, one year, or the like.

These teachings will also readily accommodate the provision of a longer term civil security shelter up to and including an indeterminate term civil security shelter that is configured and arranged to adequately shelter and sustain human life for an indeterminately long period of time. A shelter of this type will typically be characterized not only by an ability to protect its inhabitants against the rigors of the local environment and to contain a relatively large and varied supply of provisions, but by an ability to exist and operate in a fully or at least substantially independent manner. This can relate in particular to an ability to create and/or otherwise replace its consumable provisions (by, for example, growing food, creating power, and so forth).

It is also possible for such shelters to differ from one another in other ways. For example, such shelters may differ with respect to the non-survival related amenities that are provided. These differences can relate to categories of amenities (such as educational facilities, workshop facilities, food preparation facilities, communications facilities, entertainment and/or recreational facilities, or the like) and/or to a relative level or perception of quality, comfort, convenience, or the like. These teachings will also accommodate application settings that employ fractionally possessed shelters where a given civil security shelter, such as a substantially underground facility, is fractionally possessed, at least in part, by a plurality of different authorized beneficiaries.

The aforementioned civil security services 304 can comprise any of a relatively wide variety of offerings. Some examples include, but are certainly not limited to:
transportation services (where such transportation services are not ordinary mass or individual transit services but instead represent, for example, transportation away from a location that substantially lacks civil security (such as an area afflicted by a civilly-catastrophic event) and/or transportation to and/or between the aforementioned civil security facilities 303);
civil security information (including both civil security information that is generally appropriate for a large number (or all) of the authorized beneficiaries (such as civil security preparedness training or the like) as well as information that is specifically appropriate for individual ones of the authorized beneficiaries (such as personal contingency instructions that are formed (at least in part through use of the aforementioned authorized beneficiary information) and provided to guide specific authorized beneficiaries during a time of need regarding particular actions and behaviors that such specific individuals should take and observe when responding to a civilly-catastrophic event as well as consulting services that assist such individuals with respect to fortifying their relative positions and/or otherwise better protecting themselves against the effects of various civilly-catastrophic events) that is delivered prior to, during, and/or after a given civilly-catastrophic event using any medium of choice including but not limited to hardcopy, email-like services, instant messaging-like services, network-based streaming content and/or file downloads (which may or may not be browser and/or World Wide Web-based as desired), television broadcasts, radio broadcasts, face-to-face delivery techniques, telephonic-based delivery techniques, and so forth;
communications services, including long distance communication services (including, for example, wireless-based services) that are configured and arranged to provide substantially persistent communication services notwithstanding interaction of the long distance communication service with the effects of a civilly-catastrophic event (which may include, for example, satellite-based communications, quickly deployed wireless base stations (that comprise, for example, mobile terrestrial platforms, aerial platforms, and so forth), and the like);
civil security rescue services to facilitate, for example, retrieving selecting authorized beneficiaries from dangerous circumstances that are owing, at least in part, to a substantial lack of civil security (including, for example, immediate threats posed by life-threatening influences such as fire, collapsed buildings, lawless unpoliced individuals, and the like as well as less-immediate threats (such as starvation, dehydration, infection, or the like) and likely dangerous circumstances that are owing, at least in part, to an imminent likely substantial lack of civil security that can follow a substantial failure of civil infrastructure (where the specific nature of the civil security rescue services can vary greatly with the application setting; for example, by one approach, such services can comprise, at least in part, rescuing authorized beneficiaries who are located within rescue capsules that are, for example, pre-positioned and located atop a building (such as a tall building in an urban area) by airlifting such rescue capsules by use of a helicopter or the like to thereby transport the authorized beneficiaries contained therein to another location such as a rally point, a shelter, or the like);
civil security forces that are trained and outfitted to provide a variety of proactive actions with respect to meeting the challenges of a given civilly-catastrophic event (which can include actions both before the fact (in an effort to fully or partially mitigate the impact of a given civilly-catastrophic event on one or more authorized beneficiaries), during the fact, and/or after the fact);
   and so forth, to note but a few relevant examples.

By one approach, these teachings will readily accommodate providing such civil security provisions 302, civil security facilities 303, and civil security services 304 by a single provider. Such a provider can be integrally involved with designing, providing, maintaining, and offering such civil security resources 301 or can comprise an aggregator of such resources, in whole or in part, from other sources. If desired, however, these teachings can be flexibly applied in other ways. For example, the civil security provisions 302 can be provided by a first provider, the civil security facilities 303 can be provided by a second provider, and the civil security services 304 can be provided by a third provider wherein the first, second, and third providers comprise separate entities (as when, for example, these providers comprise separate legal entities having no co-ownership or common points of control). In such a case, these separate providers can meet the needs of this step by acting in an aggregated manner (directly or indirectly) with one another.

Yet other arrangements are possible. For example, a single provider can provide the civil security facilities 303 and the civil security services 304 while the civil security provisions 302 are provided by a plurality of civil security provisions providers represented here by a first civil security provisions provider through an Nth civil security provisions provider (where “N” will be understood to comprise an integer greater than one). Persons skilled in these arts will understand and appreciate that numerous permutations and combinations of these elements as well as other possibilities are available. Such alternatives are well within the scope of these teachings and are rightly considered to comprise a part of this invention.

As noted earlier, these teachings will also optionally provide for the provision of non-civil security resources. Such non-civil security resources comprise supplies and items that are not, strictly speaking, necessary to ensure human survival and hence may be viewed as luxuries. Such items can quite literally span the full gamut of available offerings and can include both unique (such as original works of art) and generally available offerings (such as jewelry, pleasure reading materials, audio playback devices, and so forth). Again, differentiations can exist with respect to actual or perceived levels of quality as pertain to such items if desired.

It should be clear that a comprehensive civil security program having a substantial number of the above-described components inherently presents a high number of permutations and combinations regarding deployment opportunities. In some cases, certain resources might be pre-deployed well prior to any particular civilly-catastrophic event. Temporary civil security shelters and a short term supply of civil security provisions, for example, can be distributed and/or provided to at least some authorized beneficiaries prior to a civilly-catastrophic event. Such pre-distribution of resources, however, cannot always address the complete challenge of deployment.

For example, not all of the civil security resources noted are necessarily suitable or even useful for meeting the needs and challenges of every civilly-catastrophic event. Specific civilly-catastrophic events, by their very nature, their unique intensity, and/or the relevant characterizing frailties and/or resiliency as correspond to a given event setting can engender very different needs on the part of such authorized beneficiaries. Different kinds of shelter and/or different kinds of provisions, for example, may be appropriate depending upon the nature of the civilly-catastrophic event. In some cases, local shelters may be sufficient and/or a deployment of survival-related provisions to the home of an authorized beneficiary will be adequate, sufficient, and even preferable from the viewpoint of all parties concerned. In other cases, evacuation may be necessary and re-location of the authorized beneficiary (either temporarily or even permanently) may be advisable or necessary. This, in turn, would render deployment of significant civil security provisions to the present location of the authorized beneficiary a waste of effort and materials.

By taking into account the kinds of information noted above, including, in particular, specific personal information regarding the authorized beneficiaries themselves provides a basis for the processor to identify appropriate deployment suggestions and/or mandatory instructions. This can relate generally to one or more of:

When to deploy a given civil security resource (for example, prior to an imminently expected civilly-catastrophic event or subsequent thereto, prior to having established any contact with an intended recipient authorized beneficiary or only after establishing such contact, and so forth);

Where to deploy a given civil security resource (for example, whether to deliver civil security provisions to a given authorized beneficiary at a first location, such as a home, or a secondary location such as a contingency delivery site, whether to preposition civil security transport vehicles proximal to a particular urban area that is expected to imminently experience a civilly-catastrophic event or within that urban area, and so forth);

How to deploy a given civil security resource (for example, whether to retain a given civil security resource in storage pending a clear and present need for that particular resource or to increase the deployment readiness of that resource to facilitate more rapid deployment should such become necessary, whether to provide particular civil security suggestions, recommendations, and/or instructions via a civil security-based television and/or radio broadcast that is generally receivable by all members of the public or via a private channel of communication intended substantially only for authorized beneficiaries, and so forth);

To whom to deploy given civil security resources (to thereby facilitate, for example, providing different civil security provisions, facilities, or services to different authorized beneficiaries to account for their differing needs and preferences notwithstanding their both having experienced a same kind of civilly-catastrophic event, and so forth);

to note but a few examples in this regard.

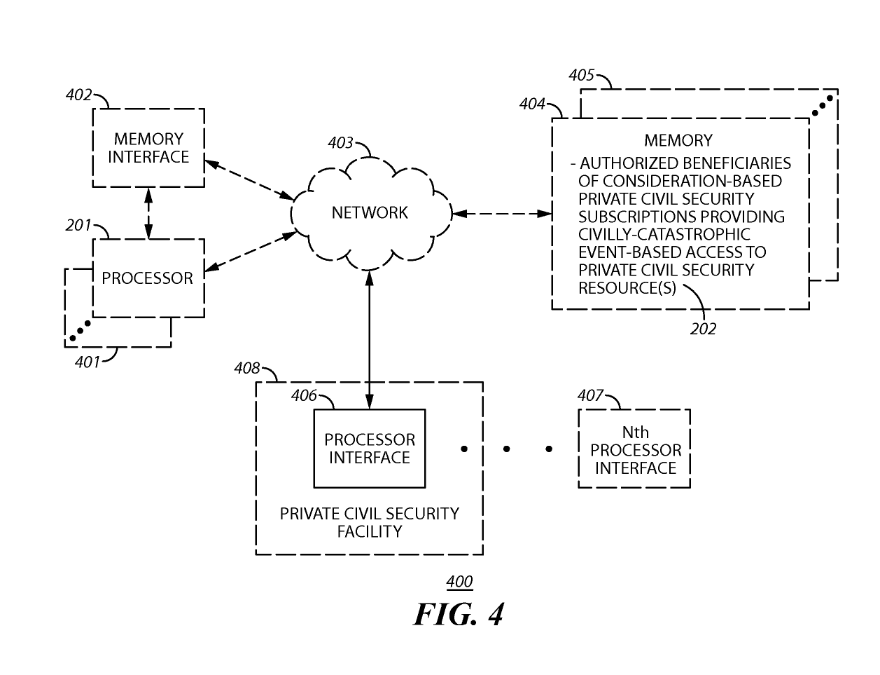

As noted above, these teachings are highly flexible and scalable and will accommodate a wide variety of application settings and needs. As an illustrative example in this regard, and referring now to FIG. 4, a given civil security system 400 may comprise a processor 201 as described above. If desired, such a civil security system 400 can comprise two or more parallel or backup processors 401 to thereby better ensure that at least one such processor will remain on-line and functional during a civilly-catastrophic event. In this regard, when using a plurality of processors, it may be useful to deploy them in a manner that tends to insulate them from the effects of a single civilly-catastrophic event. This can comprise, for example, locating such processors a large geographic distance from one another (such as many hundreds or thousands of miles apart), in different countries and/or on different continents, and so forth.

Other forms of installation diversity could also be employed if desired. For example, one such processor could comprise a fixed location installation while the redundant processor could comprise a mobile platform that could be moved from time to time. As another example, one such processor could be installed below the ground while another such processor is installed beneath a body of water.

Such a processor 201 could couple, via a corresponding memory interface 402 (and possibly through an intervening network 403 such as, but not limited to, an intranet or an extranet such as the Internet) to a memory 404 that serves to store the aforementioned information regarding the authorized beneficiaries of consideration-based private civil security subscriptions that provide civilly-catastrophic event-based access to one or more private civil security resources. As with the processor 201, one or more redundant memories 405 can be provided if desired to again provide an improved ability to persist such information notwithstanding a civilly-catastrophic event that might damage, destroy, or otherwise render unavailable such a memory 404.

This particular illustrative example of a civil security system 400 also provides a processor interface 406 that operably couples to the processor 201 (via, for example, the aforementioned network 403 when present). Such a processor interface 406 can be configured and arranged to provide access to the processor 201 to thereby facilitate deployment of the aforementioned civil security resources on behalf of the authorized beneficiaries in response to circumstances as correspond to a civilly-catastrophic event.

This processor interface 406 can comprise, for example, a user input and/or user output platform. A user input might comprise, for example, a text entry mechanism (such as a keyboard, a cursor control device, a speech recognition platform, and so forth). Such a user input could serve to permit the provision of information to the processor 201 to further inform the deployment calculations thereof or to provide, for example, a query to the processor 201 regarding needed instructions or information. It will also be understood that the processor interface 406 can comprise a World Wide Web-based interface (such as a browser-based platform) or any other client or application-based platform as may be desired.

A user output platform might comprise, for example, a display of choice (including any of a wide variety of monochrome and color displays, solid state and vacuum tube-based displays, and so forth), an audio transducer (including, for example, a text-to-speech synthesizer), and so forth. Such a display could be configured and arranged, for example, to display information as is provided by the processor 201 regarding suggested, optional, and/or mandatory recommendations or orders regarding deployment of the private civil security resources when responding to needs stemming from a given civilly-catastrophic event. As noted above, this can comprise the provision of such information with respect to actions to take with respect to one or more of the aforementioned civil security provisions, civil security facilities, and civil security services with respect to one or more of the authorized beneficiaries.

These teachings would readily accommodate the provision of more than one such processor interface 406 as is represented generally in FIG. 4 by the optional inclusion of an Nth processor interface 407 (where “N” will be understood to comprise an integer greater than one). The processor interface 406 itself can be located where desired. This can comprise, if desired, a civil security facility 408 of choice. Examples in this regard would include, but are not limited to, a private civil security tactical operations facility, a private civil security headquarters, a private civil security shelter, a private civil security vehicle, a private civil security provisions storage, aggregation, distribution, or staging facility, a private civil security transport rally-point facility, and so forth.

It would also be possible to configure such a processor interface as a portable and/or wearable platform. So configured, private civil security provider field operatives (such as, but not limited to, transport and delivery vehicle personnel, rescue personnel, and so forth) would have similar access to the processor 201 and corresponding deployment advice and instructions. Such a portable and/or wearable platform could also be provided to one or more of the authorized beneficiaries for much the same reason.

As noted above, these teachings will further accommodate maintaining such civil security resources. This can comprise, for example, maintaining the freshness and usability of civil security provisions (by replacing outdated or soon-to-be outdated supplies), replacing an existing resource with a better substitute, maintaining present and/or imminent usability of a civil security shelter or transport vehicle, updating civil security-related information to reflect current data and intelligence, vetting and re-vetting predetermined evacuation and/or transportation routes, educating and training corresponding personnel, and so forth. If desired, the aforementioned processor 201 and corresponding civil security system 200 can be further configured and arranged to facilitate such maintenance. As one simple example in this regard, the processor 201 can be configured and arranged to provide scheduled maintenance information via the processor interface 406.

Such maintenance can again be at least partially carried out as a function, at least in part, of the stored information regarding the authorized beneficiaries. As one simple example in this regard, one civil security subscription may differ from another with respect to the minimal freshness of the civil security provisions as correspond to that subscription. In such a case, information in this regard as is available from the aforementioned memory 404 can serve to inform the maintenance process to facilitate ensuring that the civil security provisions as are stored in readiness for such authorized beneficiaries is rotated and otherwise maintained in a suitably fresh state.

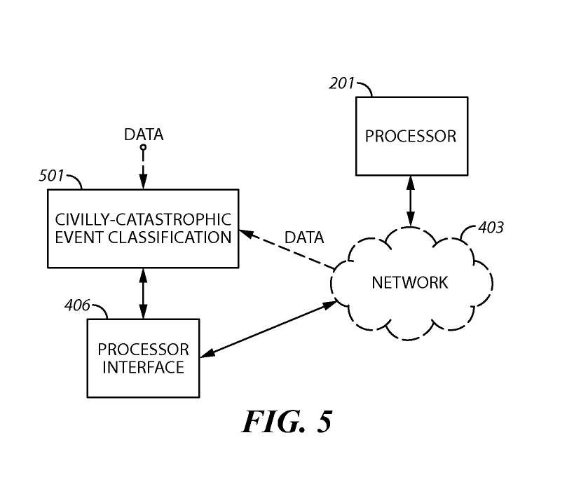

As noted earlier, such a processor 201 can also base its deployment output upon information regarding the relevant civilly-catastrophic event(s) itself As an illustrative example in this regard, and with reference now to FIG. 5, data regarding a given civilly-catastrophic event can be provided to a civilly-catastrophic event classification platform 501. Such data can be provided by one or more information sources using, for example, a direct input opportunity to the platform 501, the aforementioned network 403, or such other input opportunity as may be available in a given application setting.

This incoming data can vary greatly with the needs and/or opportunities of a given application setting. Some useful examples, however, would likely include information regarding a likelihood of at least one of:

a given civilly-catastrophic event occurring;

a given civilly-catastrophic event persisting for at least a predetermined amount of time;

a given civilly-catastrophic event occurring with respect to a particular geographic locale; and/or

a given civilly-catastrophic event exhibiting at least a particular level of impact with respect to corresponding civil infrastructure;

to note but a few examples in this regard.

The civilly-catastrophic event classification platform 501, in turn, can be configured and arranged to use such data to form, for example, one or more classifications of the corresponding civilly-catastrophic event. This might comprise a classification regarding, for example, a given category of civilly-catastrophic event (such as, for example, an event that only poses a mortal threat to exposed humans over a relatively long period of time, an event tending to present an immediate mortal threat to exposed humans, and so forth). As another example, this might comprise a classification regarding, for example, a given kind of civilly-catastrophic event (such as, for example, a natural or non-natural event, a weather-related event, as slowly-developing event, a politically-motivated event, and so forth). As yet another example in this regard, this might comprise a classification regarding, for example, a given magnitude of a civilly-catastrophic event (where such magnitude can be expressed using a metric of characterization of choice and can relate, for example, to peak intensity, average or median intensity, root mean squared-represented intensity, historical comparisons, duration, a logarithmic representation, and so forth).

By one approach, if desired, this classification can comprise classification of a given civilly-catastrophic event with respect to a classification system that uses a discrete number of classification levels. To illustrate and without intending any particular limitations in this regard, this could comprise a four or five level classification system. Such a classification system could comprise a public classification system such as that employed to rank hurricanes and tornados. Such a classification system could also comprise, in whole or in part, a private classification system that is at least substantially maintained by the provider of the private civil security resources.

These classifications may be provided on an event-by-event basis or may, if desired, constitute a dynamic classification that can vary throughout a single given civilly-catastrophic event. It would also be possible to use such a classification approach to classify the aftermath portion of a given civilly-catastrophic event. In such a case, the classifications could serve to represent the ease or difficulty by which one may expect to:

Communicate with authorized beneficiaries within an afflicted area;

Deliver civil security provisions to authorized beneficiaries within an afflicted area;

Locate authorized beneficiaries within an afflicted area;

Rescue authorized beneficiaries within an afflicted area;

Transport authorized beneficiaries within, through, and/or from an afflicted area;

Maintain civil security viability within a shelter in the afflicted area;

Maintain operational viability and effectiveness of private civil security facilities located within the afflicted area;

Attend to the medical requirements of authorized beneficiaries within an afflicted area;

and so forth, to note but a few relevant examples in this regard.

Such a civilly-catastrophic event classification platform 501 can provide such classification information to the aforementioned processor 201 by any means including, for example, via a processor interface 406 and intervening network 403 as has been described earlier. As noted earlier, this processor 201 can be configured and arranged to use such classification information to further inform its deployment determinations. Consider, for example, an illustrative example in this regard (where again the details of this example are intended only for the purposes of illustration and are not intended to suggest any particular limitations in this regard) where a four level classification system serves to rank civilly-catastrophic events with respect to their likely impact upon a given authorized beneficiary.

In this illustrative example, when the civilly-catastrophic event classification platform 501 classifies a given civilly-catastrophic event as a first level civilly-catastrophic event (meaning, in this example, that the civilly-catastrophic event constitutes a relatively mild event) the processor 201 might determine to wait for authorized beneficiaries to proactively signal a need for civil security resources access before facilitating such access and even before taking significant preparatory private civil security resources deployment actions. This, of course, may also depend upon the specific terms and conditions of a given private civil security subscription and/or the preferences or requirements as pertain to individual authorized beneficiaries. It would be possible, for example, for a given authorized beneficiary to require an immediate automatic provisioning of their private civil security provisions upon the occurrence of a first level civilly-catastrophic event notwithstanding that the private civil security provider's actions will otherwise tend towards the more reactive posture described above. Such individual requirements, of course, would be available to the processor 201 via the above-described memory.

To continue this illustrative example, when the civilly-catastrophic classification platform 501 classifies a given civilly-catastrophic event as a second level civilly-catastrophic event (meaning, in this example, that the civilly-catastrophic event constitutes a relatively more harsh event), the processor 201 might determine now to continue waiting for particular authorized beneficiaries to proactively signal their need for private civil security resources access but to also proactively take one or more significant preparatory private civil security resources deployment actions. This might comprise, for example, ensuring that transport vehicles are fully fueled, that delivery personnel are available, that aggregated provisions appropriate for corresponding targeted authorized beneficiaries are formed from dis-aggregated mass stocks, that potential evacuation routes are vetted by on-site inspections, that civil security provisions en mass are pre-positioned near or in the afflicted area to permit a more rapid distribution of such provisions should the need arise, that medium-term civil security shelters may be prepared for possible habitation, that medical supplies (such as respirators or the like) may be moved from other locations to be rendered more available in the event of their need, and so forth. Again, the ordinary response to a level two civilly-catastrophic event can be modified for individual authorized beneficiaries as a function of the contents of their personal stored information.

To continue further with this illustrative example, when the civilly-catastrophic classification platform 501 classifies a given civilly-catastrophic event as a third level civilly-catastrophic event (meaning, in this example, that the civilly-catastrophic event constitutes a considerably more harsh event), the processor 201 might determine now to initiate an attempt to contact the authorized beneficiaries to determine whether access to the private civil security resources should be effected. Such attempts at contact could be conducted using any of a variety of approaches. By one approach, for example, operators for the provider of private civil security resources could attempt making such contact using telephones (either wireless or wired), short wave radio, email, instant messaging, satellite transceivers, or the like. It would also be possible to use an automaton for such purposes. For example, an automated dialing system could use synthesized and/or pre-recorded speech content to provide selected messages and queries to the contacted authorized beneficiaries and voice recognition, key pad entries, or the like to ascertain the authorized beneficiary's responses to such content.

When such attempts fail in individual instances, the processor 201 might then further determine to automatically take steps to proactively provide the particular authorized beneficiaries with access to their corresponding private civil security resources. This could comprise, for example, automatically delivering private civil security provisions to a predetermined location as pertains to each authorized beneficiary (as revealed by the stored information as corresponds to the authorized beneficiaries), automatically dispatching rescue personnel to locate and extract the authorized beneficiary (possibly relying upon, for example, the aforementioned schedule information for the authorized beneficiary to determine a likely present location of that authorized beneficiary), and so forth.

To conclude this illustrative example, when the civilly-catastrophic classification platform 501 classifies a given civilly-catastrophic event as a fourth level civilly-catastrophic event (meaning, in this example, that the civilly-catastrophic event constitutes a most extreme event), the processor 201 might determine now to automatically take steps to proactively provide the authorized beneficiaries with access to their corresponding private civil security resources even in the absence of a proactive signal from the authorized beneficiaries of a need for such access and even in the absence of initiating an attempt to contact such authorized beneficiaries to determine whether such access should be facilitated. In such a case, the processor 201 may determine that an immediate deployment of civil security provisions, facilities, and/or services is the appropriate response. Once again, of course, such actions may be altered (and perhaps considerably) for specific authorized beneficiaries to take into account the stored information for each such authorized beneficiary.

Again, these examples are intended only for the purposes of illustration. Other scenarios are possible and even likely. For example, in the case of a fourth level civilly-catastrophic event, the processor 201 may further take into account other information regarding the nature of the civilly-catastrophic event itself. In a case where the opportunities for authorized beneficiaries within the afflicted zone to function well if provided with suitable civil security provisions are poor (as when, for example, the afflicted zone is, and will remain for some extended period of time, exposed to a dangerous environmentally-borne life-threatening hazard), the processor 201 may conclude to dispense with deploying civil security provisions (beyond, perhaps, sufficient provisions to meet relatively immediate needs) and to prompt, instead, deployment of evacuation transport vehicles to effect a relatively immediate removal of authorized beneficiaries from within the afflicted zone.

So configured, authorized beneficiaries will have concrete, predictable, meaningful, and effective access to various categories of privately supplied civil security resources in the event of a civilly-catastrophic event. These steps are readily facilitated without dependency upon (and perhaps even in spite of) governmental oversight, participation, or control. The logistic difficulties of deploying a wide variety of available civil security provisions, facilities, and services are greatly tempered through application and use of these teachings. As noted above, these teachings are highly flexible and are readily scaled to accommodate a wide variety of operational settings and contingencies. Importantly, via these teachings individuals can benefit from a greatly increased opportunity to bring a considerably improved measure of security into their lives, knowing that, should a civilly-catastrophic event indeed be visited upon them, they will have appropriate and reliable access to civil security resources.

A number of general examples have been provided above. A number of more specific examples will now be provided. Again, these examples are not to be construed as comprising an exhaustive listing of all possibilities in this regard; instead, these examples are intended as illustrative of the many ways by which these teachings can be applied to accommodate the needs and/or opportunities as characterize a given application setting or instance.

### EXAMPLE 1

In this example, a given authorized beneficiary's information stipulates that this authorized beneficiary has subscribed to a rescue service. Accordingly, this authorized beneficiary has been supplied with a rescue beacon that includes a radio frequency transmitter that can transmit a location beacon signal, a radio frequency receiver that can receive a remote control command, and a strobe light. In this case, however, this authorized beneficiary's information also reveals that she has not yet completed her recommended rescue protocols training as is offered by the provider of civil security benefits. Such training would provide, for example, training with respect to when, and how, to initiate a high power transmission of the aforementioned radio frequency location beacon signal that can be used to facilitate quickly locating the authorized beneficiary during a rescue exercise. Accordingly, when automatically facilitating the deployment of a rescue effort to rescue this authorized beneficiary in response to the occurrence of a given civilly-catastrophic event, these teachings can be employed to effect the automatic transmission of a remote control signal to this authorized beneficiary's particular rescue beacon to cause automated activation of the transmission function. This action can be taken automatically and without any human supervision if desired. Such an action can greatly serve to facilitate the likely success of a deployed rescue mission for such an individual.

### EXAMPLE 2

Some civilly-catastrophic events can cause ordinary transportation to become difficult or even relatively impossible for authorized beneficiaries employing standard automobiles or the like. To meet such a need, the provider of civil security resources can provide a civil security service comprising transport facilities that will travel a specific route during a given time of need to pick up authorized beneficiaries of such a service using vehicles and trained crews suitable to meet the challenges of such a route and task. Such a service, of course, need not be applied during less trying times. Accordingly, the above-described teachings can be applied to facilitate (by indirect or direct control of) the deployment of such a civil security transport route.

This can comprise, for example, establishing, prior to, during, and/or following the occurrence of a given civilly-catastrophic event, one or more routes that take into account criteria such as authorized beneficiary locations, throughway integrity and challenges, the need for speed when effecting the evacuation of the authorized beneficiary's, the frailties and/or capabilities of given authorized beneficiaries along a given projected route (to take into account, for example, such things as configuring a route to first pick up an authorized beneficiary who is well-trained in civil security responses and to then pick up an authorized beneficiary who is both relatively untrained and who faces mobility challenges such that the former can provide assistance with respect to evacuating the latter), and so forth. Again, such routing can be partially or fully automated and conducted, in whole or in part, through use of the above-described civil security resources deployment facilitation teachings as desired.

### EXAMPLE 3

By one approach, the aforementioned consideration-based private civil security subscriptions may be differentiated, at least in part, by a relative amount of flexibility the corresponding authorized beneficiary has with respect to selecting, for example, a given civil security shelter during a time of need. This could comprise, for example, restricting one category of authorized beneficiary to use of only a single civil security shelter (which might be located, for example, in their home town) while permitting another category of authorized beneficiary to use any civil security shelter that is operated by the provider of civil security benefits. In such a case, admission of such an authorized beneficiary into a given civil security shelter could be entered as information regarding that authorized beneficiary and then used to inform the subsequent deployment of corresponding civil security resources. To illustrate, such an authorized beneficiary might have certain needs or preferences that are reflected in their choice of civil security provisions. Such information could be used to automatically facilitate the forwarding of specific items to this particular shelter to ensure the availability of such items for this particular authorized beneficiary. Such items might be forwarded, for example, from a central storage facility or from a designated home shelter for this particular authorized beneficiary as appropriate.

### EXAMPLE 4

In some cases the provider of civil security benefits may have mobile civil security shelters available for deployment. This could comprise, for example, trailer or motorhome-styled mobile shelters, rail-borne mobile shelters, air-borne mobile shelters, and/or water-borne shelters (including both self-powered vessels as well as towed or pushed vessels such as barges or the like). Such shelters are likely sufficient to meet the needs of several kinds and categories of civilly-catastrophic events. Optimum deployment of such civil security resources can comprise a daunting task, however.

Being mobile, deployment decisions can take into account the timing of such deployments, the routing of such deployments, the provisioning and crewing of such platforms, the target destinations of such deployments, the matching of shelter capacities and capabilities to projected needs (both generally speaking as well as that which pertains to the individual needs and/or preferences of individual authorized beneficiaries), and so forth. The teachings described above are well suited to facilitate the appropriate deployment of such mobile civil security shelters as such factors already comprise, or can readily comprise, the availability and use of information and data that can readily support the consideration of such factors and the making of corresponding deployment decisions in a partially and/or fully automated manner.

### EXAMPLE 5

As noted earlier, civil security provisions as provided to the authorized beneficiaries can vary in a wide variety of ways. In some cases the particular civil security provisions will vary as a function, at least in part, of the nature of the instigating civilly-catastrophic event. When the event is associated, for example, with a particular air borne threat, such civil security provisions can specifically include supplies and equipment to provide protection against this particular threat.

It is also possible, however, that the specific civil security provisions as are provided for a given authorized beneficiary will vary as a function, at least in part, of the needs and/or preferences of the authorized beneficiary themselves. In such a case the specific provisions can vary with respect to kind, brand, quantity, cost, quality, or other qualifier of choice as selected and/or specified by the authorized beneficiary as per the terms and conditions, for example, of their corresponding subscription. The teachings set forth herein will readily accommodate holding information regarding such selections and choices as part of the information that is stored for each authorized beneficiary. This, in turn, will render such information available to facilitate the maintenance, readiness, staging, acquisition, packing, selecting, and provisioning of such supplies on behalf of and to the corresponding authorized beneficiaries.

### EXAMPLE 6

In some cases, the provider of civil security benefits may have pre-placed in various locations a variety of civil security provisions. These provisions might be presented in a relatively bulk manner or may, if desired, be formed into ready-to-go carriable containers (such as a backpack, briefcase, duffel bag, or the like) that each contain, for example, a sufficient variety and quantity of various categories of life sustaining supplies to support an average authorized beneficiary for, say, one day, three days, one week, or the like. The location and content of such caches can comprise information that is available to the above-described deployment facilitation infrastructure.

Accordingly, corresponding information regarding such caches can play a part in the deployment recommendations of such a system. For example, by one approach, automated transmissions can be provided during a time of need to alert specific authorized beneficiaries regarding the locations and/or access requirements of such caches as are nearest (or likely to be nearest) to them. As another example, information regarding the use of such supplies can be monitored (either generally or specifically as regards, for example, the specific supplies removed and/or the identity of the authorized beneficiary who removed them) to thereby further inform subsequent civil security resource deployment decisions. To illustrate, when it is known that a given authorized beneficiary now has a backpack that contains a particular civil security provision that is relevant to the needs presented by a given civilly-catastrophic event, an automated transmission can be sent to that authorized beneficiary to instruct them with respect to the proper use of that particular civil security provision.

### EXAMPLE 7

In anticipation of financial systems confusion, tumult, and/or breakdown as may occur as a result of a civilly-catastrophic event, the aforementioned consideration-based private civil security subscriptions may also provide for civilly-catastrophic event-based access to cash and/or readily bartered materials (such as precious metals, gemstones, or the like) via private civil security automated teller machines. In such a case, the location and contents of such machines can comprise information provided to the aforementioned processor and, in turn, the stocking and/or enablement of such machines can be placed under the control thereof.

So configured, for example, the processor can identify particular machines in particular locations to be stocked with particular kinds of currency (such as local currency, currency of a neighboring country, and so forth) and/or non-cash barterable materials of choice prior to the occurrence of a forecasted imminent civilly-catastrophic event to ensure the availability of suitable purchasing power for the authorized beneficiaries who are likely to be impacted by that civilly-catastrophic event. The processor can also control the enablement of such machines as a function of the information described herein. In particular, the ability of a person to receive cash/barterable materials from such a machine can be conditioned upon the machine receiving a particular enabling signal that originates, directly or indirectly, from the processor in response to determining a need to facilitate the functional deployment of such a resource.

### EXAMPLE 8

In some cases, a given provider of private civil security benefits may chose to pre-position civil security provisions near, or within, a given area that is likely to be (or is in fact) impacted by a given civilly-catastrophic event. This, of course, carries a risk that some or all of these pre-positioned provisions will be destroyed by a civilly-catastrophic event or otherwise rendered partially or fully unavailable for use. Notwithstanding such a risk, however, it may still be desirable to provide for the pre-placement of a certain quantity of civil security provisions in order to increase a likelihood of being able to effect a timely deliver of such provisions to authorized beneficiaries.

To mitigate, at least to some extent, the risk of loss, it may be useful to place partially or fully redundant stores in this regard in a variety of discrete geographic locations. These locations, along with the quantity and types of provisions stored at each such location can comprise information provided to the aforementioned processor to further inform its deployment recommendations. For example, deployment instructions can be provided that represent an efficient use of undamaged supplies that are closest to authorized beneficiaries in need while also ensuring that additional supplies as may be needed (immediately or in the foreseeable future) are transferred from other locations to replace the presently distributed provisions.

### EXAMPLE 9

If desired, the provider of civil security provisions can permit a given authorized beneficiary to themselves provide one or more items to be held on behalf of the authorized beneficiary and to be rendered available to that authorized beneficiary during a civilly-catastrophic event-based time of need. Such items might comprise, for example, prescription medications, alcoholic beverages, personal weapons and/or ammunition, a family heirloom, a work of art, and so forth. By one approach, for example, such items can be placed in a secured container that is then stored on behalf of the authorized beneficiary. Such storage can arrange for segregation of such a container from other provisions or can, if desired, comprise inclusion of that container with other civil security provisions as have been packed together as a discrete unit to be tendered to the authorized beneficiary during a corresponding time of need. Again, corresponding information regarding such items and their container(s) can comprise authorized beneficiary information as is stored for use by the aforementioned processor.

Accordingly, the storage, staging, transport, and/or delivery of that container/item can be controlled by the processor to aid in facilitating the proper deployment of this particular resource during a civilly-catastrophic event. This might comprise, for example, combining information regarding a present location of a given authorized beneficiary with information regarding an imminent civilly-catastrophic event to, in turn, yield an automated instruction to move the container/item from a first storage venue to a staging location proximal to the present location of the authorized beneficiary to thereby reduce the amount of time that would be required to provide that authorized beneficiary with access to that particular resource during a civilly-catastrophic event-based time of need.

### Example 10

In some cases, the provider of civil security benefits may have ruggedized containers that can serve to safely store civil security provisions notwithstanding harsh local conditions (such as, but not limited to, likely flooding, high winds, intense precipitation, airborne projectiles, heat, concussive forces, lawless unpoliced persons, and so forth). The decision to use such containers in preparation for, or when responding to, a given civilly-catastrophic event can again comprise a deployment decision to be informed by the aforementioned processor based upon the authorized beneficiary information and other information as may be available thereto.

In some cases, for example, a given authorized beneficiary may have contracted for such a level of service. In such a case, the processor can serve as an automated means for observing the civil security benefits provider's contractual obligations in this regard. In other cases, the use of such containers may be fully discretionary on the part of the civil security benefits provider and the deployment decision based upon such things as the nature of the civilly-catastrophic event itself, the local terrain and likely functional availability of roadways or other ordinary means of delivering goods, the urgency by which the civil security provisions may themselves be needed, and so forth.

### EXAMPLE 11

In some cases, the aforementioned consideration-based private civil security subscriptions may be offered to potential authorized beneficiaries through third party agents. In some cases, these third party agents may work directly on behalf of the provider of civil security benefits or may work instead on behalf of an underwriter that, in turn, works in conjunction with the provider of civil security benefits.

In such cases, these third party agents may be remunerated in any of a variety of ways. For example, such an agent may receive a flat payment for each referred and/or successfully subscribed authorized beneficiary. By another approach, such an agent may receive, instead, a percentage interest in the (partial or whole) value of the subscription. By yet another approach, such an agent may receive a higher level of compensation for a first period of time (such as a first year) as pertains to a given subscription with subsequent follow-on periods of time (representing, for example, renewals of such subscriptions by the authorized beneficiaries) providing a reduced level of compensation. There can also be varying levels of relevant compensation that are tied to the constituent elements of particular civil security benefits packages (where, for example, compensation to the agent may be relatively higher for a subscription that includes a particular category of civil security resource as versus one that does not).

In such cases, the stored information that is available to the processor regarding the authorized beneficiaries can also serve to inform the efficient, timely, and accurate compensation of such third party agents. Accordingly, by one approach, such a processor can be further configured and arranged to track such third party agent remuneration programs to facilitate the remuneration of such agents as per their relative performance.

### EXAMPLE 12

In some cases, at least some civil security provisions may be pre-aggregated into corresponding sub-units that can be combined with one another to form a unit of civil security provisions suitable to meet the needs and preferences of a given authorized beneficiary. By one approach, for example, such pre-aggregated sub-units might each constitute provisions that are, generally speaking, suitable for addressing a particular category or kind of survival need. To illustrate, such sub-units could variously have contents that primarily are each directed to one of:

nutritional items;

hydrating items;

protective clothing (to provide protection against the elements and/or the environmental effects of a given civilly-catastrophic event);

breathable air items (such as filters, air movers, oxygen sources, carbon dioxide absorbers, and so forth);

food preparation items;

tools;

power sources and/or implements;

communications devices;

medical supplies;

shelter materials and/or amenities;

and so forth, to note but a few examples.

By one approach, such sub-units can be stored in corresponding containers that are designed to interlock with one another. Such an interlocking design can facilitate forming these provisions into an easily transported unit. For example, by interlocking such sub-units together in this manner, the aggregated whole can be readily lifted and moved by forklift, pallet, crane, hoist, rope, or otherwise. Such interlocking containers may also be useful to the recipient authorized beneficiary who can potentially interlock such containers together in various ways to form shelter walls, roofs, or other structures of interest and purpose.

By one approach, there may be a variety of different such containers. Such containers may differ with respect to their relative size, their relative interlocking features, the availability of external manipulation surfaces, and so forth. Such information can comprise information that is rendered available to the aforementioned processor and hence can be also taken into account when facilitating the deployment of such containers when distributing civil security provisions. As but one example in this regard, the processor can determine to use a particular selection of such containers in order to assure optimum use of available transport facilities. This can comprise, for example, selecting a variety of such containers as will yield an aggregated whole having a resultant form factor that will fit within available transport dimensions while also tending to ensure substantially complete use of the available transport space. By this approach, relatively optimized movement of civil security provisions can be assured, thereby tending to ensure that needed provisions are provided as efficiently and quickly as possible given available resources in this regard.

### EXAMPLE 13

It would also be possible for such units and sub-units to be differentiated from one another with respect to whether such units/sub-units contained sources of electrical power (such as stored energy sources or electrical generators of various kinds, to note but two general examples in this regard). Similarly, the containers by which such units/sub-units could be moved and/or delivered or otherwise provided could include some containers that integrally contained such a resource. When the inventory of available containers and/or civil security provisions in this regard is rendered available to the aforementioned processor, such information can be taken into account when facilitating the deployment of such resources.

To illustrate, the processor may elect to instruct the use of civil security provisions containers that include an integral power source when facilitating the deployment of civil security provisions to an area of need when other information available to the processor indicates that this constitutes an appropriate deployment of resources (as may be the case, for example, when the nature of the instigating civilly-catastrophic event is one that ordinarily results in a longer term lack of electricity or when the subscription terms and conditions for a given authorized beneficiary requires the provision of such a resource/container when otherwise deploying civil security provisions on behalf of this particular authorized beneficiary).

### EXAMPLE 14

As noted above, a given provider of civil security benefits may provide a variety of different civil security shelter options. This can include civil security shelters that differ from one another with respect to category, kind, location, and/or capacity. Some such shelters, for example, may be intended (and hence correspondingly configured and arranged) to only support a relatively small number of authorized beneficiaries for a relatively short period of time while other such shelters may be intended for longer term usage for a similar, or larger, number of authorized beneficiaries. There can even be civil security shelters that are designed and provisioned in a manner to essentially constitute indeterminate length facilities in that they have an ability to re-provision themselves with a variety of survival requirements.

Even shelters that are otherwise effectively the same with respect to design, function, provisioning, and intended use can be differentiated with respect to their location; some such shelters can be located, for example, within or near to an urban area while others are located in remote areas. As another example, some such shelters may be located within a same sovereign territory as is native to the authorized beneficiary while other such shelters may be located in other sovereignties or even in a sovereign-free location (such as a privately-owned island, boat, or stationary platform in international waters).

Information regarding such civil security shelters can comprise part of the information that is rendered available to the aforementioned processor for the purposes of these teachings. Such information can comprise, by way of example and not by way of limitation, information such as:

location;

external threat abatement capabilities (such as, for example, capabilities to withstand various external threats to survival such as flooding, concussive events, heat, cold, ionizing radiation, dangerous air borne chemical agents, dangerous air borne biological agents, lawless individuals and groups, and so forth);

ease or difficulty of access (due to distance, lack or existence of roadways, railways, waterways, landing strips or pads, and the like);

capacities (for authorized beneficiaries, provisions, personnel, and so forth);

accommodations and facilities (such as, but not limited to, sleeping quarters, food preparation facilities, dining facilities, personal hygiene facilities,

medical care facilities, equipment, personnel, power generation facilities, fuel reserves, business services facilities, and so forth); and/or

amenities (such as, but not limited to, entertainment facilities, spectator and/or participatory sporting facilities, education and training facilities, materials, and personnel, commissary facilities, and so forth);

to again note but a few examples in this regard.

Such shelter information can then be employed in accordance with these teachings to facilitate the deployment of shelter resources. This can comprise, for example, ensuring that authorized beneficiaries who have contracted to receive access to a particular kind of shelter during a time of need will be so accommodated. This can lead, for instance, to the aforementioned processor automatically instructing the bringing-on-line of a suitable shelter during a time of need (by assigning personnel, enabling access protocols, breaking out provisions, and otherwise generally bringing shelter facilities and capabilities from a dormant quiescent mode to a ready-to-receive-inhabitants state. This could also lead, as another illustrative instance, to arranging for a first transport vehicle to pick up only authorized beneficiaries who are to be transported to a first shelter and for arranging for a second transport vehicle to pick up only authorized beneficiaries who are to be transported to a different, second shelter. Numerous other possibilities in this regard are of course possible.

Such information can also be used to inform subsequent shuttling of authorized beneficiaries between such shelters. For example, as a given civilly-catastrophic event plays out, it may be useful or even necessary to move authorized beneficiaries from one shelter to another (to thereby further remove such authorized beneficiaries further away from a civilly-catastrophic event-based threat (or threats), to better aggregate such authorized beneficiaries to thereby better serve their needs, and so forth). The information available to the aforementioned processor can be employed in this regard to facilitate appropriate movements of such authorized beneficiaries from one shelter to another. Again, this can include directing such deployments in a way that leverages the information that is stored for such authorized beneficiaries regarding their needs, preferences, requirements, and so forth. Such information could eventually be used, for example, to facilitate co-sheltering authorized beneficiaries who share a particular preferential affinity such as a shared religion, political conviction, culture, dietary regimen, and so forth.

### EXAMPLE 15

As noted above, in some cases, a provider of civil security benefits may wish to pre-position civil security provisions to better ensure the rapid availability of such provisions during a time of need within an area afflicted by a civilly-catastrophic event. By one approach, this can include the use of hidden caches of civil security provisions. Such hidden caches may be buried or otherwise hidden behind walls, within buildings (including even personal storage facilities), on barges or boats, within cars or trucks, inside of dumpsters or other containers of choice, and so forth. In such a case the location and contents of such caches (as well as information regarding their present contents, condition, and/or accessibility) can comprise information that is rendered available to the aforementioned processor. This information can then be utilized and leveraged by the processor when facilitating the deployment of these and other civil security resources.

For example, when available information reflects that other civil security provisions as might have otherwise been available to a given authorized beneficiary are, at this time, unavailable, the processor can automatically instigate the transmission of information to this particular authorized beneficiary regarding the existence, location, contents, and/or access protocol that the authorized beneficiary can employ to gain access to the contents of a particular such hidden cache.

As a related example, the processor can, in the larger scheme of things, be providing information to the authorized beneficiary and/or other personnel to eventually lead the authorized beneficiary to a given civil security facility where the authorized beneficiary can receive, for example, shelter, provisions, and so forth. In such a case, and with this larger goal and plan in mind, the processor can select a particular hidden cache that is most consistent with the authorized beneficiary' planned and/or likely route in order to ensure both that the authorized beneficiary receives needed provisions and that the authorized beneficiary's progress with respect to the overall plan is not unduly upset or delayed.

### EXAMPLE 16

In the examples above, the general presumption is that the authorized beneficiary comprises a particular individual who is known, specifically, to the provider of civil security benefits. In some cases, however, this may not be the case. It is possible, for example, for a given government or governmental agency to contract with such a provider of private civil security benefits to provide in some specified manner for certain civil security benefits for members of the public as well. As but one example of many in this regard, a given city might arrange for such civil security benefits to be provided to the citizens of that city during a time of need. This might comprise the provision of individual benefits (such as provisions to be delivered to specific individuals) or might comprise the provision of group benefits (by, for example, stocking and operating a provisions distribution center that members of the public can visit to obtain their allotment of civil security provisions or the like).

In such a case, the information stored for use in accordance with these teachings might comprise, in addition to (or in lieu of) specific information regarding particular authorized beneficiaries, information regarding the number of people residing at particular service areas, the number of schools within that area along with the operating days and hours of such schools, the location and staffing of various government offices within the service area, protocols to be employed when providing access to civil security resources during a time of need to ensure that ineligible persons are not inappropriately serviced, information regarding wireless public safety communications protocols (such as utilized frequency bands and channel spacing, modulation, encryption keys, and the like), and so forth.

Such information can again then be utilized by the aforementioned processor when facilitating the deployment of civil security resources on behalf of a public base of authorized beneficiaries. This can comprise, for example, ensuring that particular civil security provisions are delivered to the care of only certain specified government representatives during a time of need, automatically dispatching rescue services to extract key government representatives during a time of need, providing a mobile operations center for the use of government authorities during a time of need that is pre-configured to operate compatibly with that government's public safety communications network(s), and so forth).

In a related example, the provision of such civil security benefits may be underwritten and/or sponsored, in whole or in part, as a charitable gesture on the part of one or more philanthropists. In such a case, again, the identity of the specific authorized beneficiaries may not be known to (or even precisely knowable by) the provider of civil security benefits prior to the occurrence of a civilly-catastrophic event that triggers the need to provide access to the corresponding civil security resources. Information regarding the metes and bounds of the scope of such generosity can be employed by the processor when determining when, where, how, and/or to whom to provide access to such civil security resources during a corresponding time of need.

### EXAMPLE 17

In some cases, the provider of civil security benefits may be willing to accept a bearer instrument (such as a bearer certificate, token, or the like) as being sufficient to grant access during a time of need to one or more corresponding civil security resources. In effect, a given party can purchase such a bearer instrument that provides civilly-catastrophic event-based access to particular civil security resources (such as, for example, a given civil security shelter, a given quantity and/or type of civil security provisions, a given civil security service (such as transport away from an area experiencing considerable civil unrest due to a civilly-catastrophic event), and so forth) and then hold that bearer instrument for their own benefit or present that bearer instrument to another (such as a family member, an employee or key associate, a guest, a lottery winner, and so forth). The holder of that bearer certificate would then have civilly-catastrophic event-based access to the corresponding civil security resources.

In such a case, corresponding information regarding such bearer instruments could comprise some of the information that is rendered available for use as per these teachings. By one approach, the aforementioned processor could be informed of the presentation of such bearer instruments when and as they are presented for redemption during a time of need. This, in turn, could be used to facilitate the automatic deployment of additional civil security provisions to replenish supplies that were provided to meet the needs of a given bearer instrument, to ready and/or actively open additional civil security shelters to accommodate both known authorized beneficiaries and the redeemers of such bearer instruments, and so forth. The active use of such information in this manner could greatly relieve the need to otherwise hold essentially all such facilities open and available during a time of need, to greatly overstock provisions at various locations, and so forth in order to meet the needs of servicing such bearer instruments when and as they are presented for redemption.

In a somewhat related example, the provider of civil security benefits may be willing, at least under some circumstances, to process instant subscriptions during a time of need (at least, for example, so long as sufficient civil security resources remain available to accommodate such late participants). These teachings can be readily employed and leveraged to facilitate the vetting of the provider's deployed and/or deployable resources to determine whether such an instant subscription can be appropriately extended in a given instance by determining whether such resources are in fact sufficient to reasonably support this extra individual. Similarly, the aforementioned processor can employ incoming information regarding incoming instant subscribers to track and monitor the sufficiency of already deployed resources and to advise or instruct the deployment (or preparedness to deploy) additional resources as may be necessitated through the acceptance of such additional authorized beneficiaries.

### EXAMPLE 18

The aforementioned information regarding authorized beneficiaries, civilly-catastrophic events, and other related information of interest can comprise both currently relevant and active information as well as historical information. Such information can therefore be utilized further to inform the pricing of given civil security benefits for particular authorized beneficiaries within particular areas as a function, at least in part, of an analysis and sense of the corresponding risk that such individuals will, in fact, likely need to act upon their right to access such benefits in response to a given civilly-catastrophic event. With this in mind, the aforementioned processor can further be configured and arranged to contribute to, or even to dictate, the pricing and other relevant terms and conditions regarding the provision of certain civil security benefits to particular authorized beneficiaries. This can naturally (and appropriately) lead to assessing authorized beneficiaries in higher risk areas a relatively higher amount of consideration for a same level of benefits than authorized beneficiaries in areas that constitute lower risk areas.

Such information could also be used to generally facilitate the offering of appropriate civil security benefits to particular individuals. For example, the aforementioned processor can be configured and arranged to note potential problems with respect to a given authorized beneficiary's (or a potential authorized beneficiary's) personal information and the civil security resources being offered. To illustrate, the processor could be configured and arranged to flag (or to otherwise prohibit) the offering of civil security transport to an authorized beneficiary who lacks personal mobility to such an extent that they would unlikely be able to transport themselves to a pick-up point to avail themselves of such a benefit. In such a case, instead, the processor could be configured and arranged to only accept, or to suggest as an alternative, civil security rescue services to provide for the movement of such a person. This kind of comparison and control could be implemented in real-time and/or during an application approval process, for example, as desired.

### EXAMPLE 19

If desired, the offering and/or support of such consideration-based private civil security subscriptions can further accommodate the use of a loyalty rewards program. For example, authorized beneficiaries might gain loyalty rewards program points by one or more of:

renewing their subscription for another term;

upgrading an existing subscription to a higher tier of benefits;

referring a new authorized beneficiary to the provider of civil security benefits;

purchasing commodities from a third party who, in turn, provides consideration to the provider of civil security benefits in exchange for providing the purchaser of such commodities with such loyalty rewards program points;

and so forth, to note but a few illustrative examples in this regard.

In such a case, information regarding such a loyalty rewards program, including the loyalty rewards program points as have been accumulated and/or redeemed by various ones of the authorized beneficiaries, can comprise information that is provided to the aforementioned processor. This, in turn, will facilitate use of such information by the processor when administering such a program and/or when facilitating the deployment of civil security resources as per these teachings. As one illustrative example in this regard, such points may be automatically redeemable for an upgraded unit of civil security provisions during a time of need. In such a case, the processor can automatically arrange for ensuring that the provisions destined for a given authorized beneficiary are suitably upgraded to reflect this obligation and to also, if desired, arranged for the loyalty rewards program account of that authorized beneficiary to be appropriately debited.

### EXAMPLE 20

The civil security services supported by a given provider of civil security benefits may include a live operator or civil security concierge that the authorized beneficiary may contact using, for example, their (wired or wireless) telephone, an OnStar-like interface in their vehicles, a shortwave radio, a satellite radio, or the like. Such a service could provide live instructions and information to the authorized beneficiary regarding unfolding civilly-catastrophic events, evacuation recommendations and routing, the locations of available civil security provisions, the fashioning of a make-shift civil security shelter using materials and facilities at hand, the use of civil security provisions as may be presently available to the authorized beneficiary, and so forth.

In such a case, the aforementioned processor can be readily configured and arranged to facilitate such interactions via, for example, the aforementioned processor interface. Via that processor interface, for example, a given such operator/concierge can learn, for a given calling authorized beneficiary, what relevant training or skills the caller may have, what civil security provisions are likely immediately available to that particular caller, what civil security facilities are presently near to that caller, which civil security facility this particular authorized beneficiary is supposed to be heading for at the present time, likely civilly-catastrophic event-based impediments, obstacles, and/or dangers that may be in the present area of the caller, and so forth. So configured and arranged, the deployment and use of such a civil security operator/concierge can be greatly leveraged and supported to the benefit of all parties concerned.

### EXAMPLE 21

By one approach the civil security services offered by a given provider of civil security benefits can include the offering of a civil security tip-of-the-day. Such a tip-of-the-day can be general in nature or can be specific to a given authorized beneficiary. For example, the tips offered to a particular authorized beneficiary can be specific to the particular civil security resources to which the authorized beneficiary has subscribed access. To illustrate, this might comprise tips regarding the proper usage of the particular civil security provisions that will be available to the authorized beneficiary during a time of need, tips regarding expectations management and training as pertains to the particular civil security transportation to which the authorized beneficiary will have access during a time of need, and so forth.

To facilitate the appropriate targeting of such tip content for individual authorized beneficiaries, the aforementioned processor can again be configured and arranged to inform the selection of a particular tip from amongst a plurality of available tips as a function, at least in part, of the particulars of a given authorized beneficiary's subscription package, the authorized beneficiary's existing level of training and/or experience, and so forth through judicious use of the information regarding the authorized beneficiaries.

### EXAMPLE 22

As noted above, the information for at least some of the authorized beneficiaries can comprise information regarding their medical history, their present health, and their pharmaceutical needs. The processor can employ such information to facilitate the deployment of corresponding resources during a time of need. This can comprise, of course, stocking and maintaining the freshness of the medications that the authorized beneficiary will require when unable to access ordinary channels to acquire their medications during a civilly-catastrophic event. This can also comprise, however, using such information to facilitate the deployment and availability of potentially related resources. To illustrate, a given authorized beneficiary's medical condition information and/or pharmaceutical requirements may strongly suggest a chronic respiratory condition. This, in turn, may be used by the aforementioned processor to also provide for the deployment of, say, respirators to ensure the availability of such a resource when supporting the needs of such an authorized beneficiary. As another example, the medical information for a given authorized beneficiary may suggest an immune system deficiency. In such a case, the processor can be configured and arranged to suggest or to otherwise provide for the deployment of various medical aids in this regard (such as antivirals, antibiotics, specific vitamins, and so forth) in conjunction with this particular authorized beneficiary in order to anticipate the likely needs of such a person during a time of need.

### EXAMPLE 23

As noted above, the information available to the processor to facilitate the deployment of civil security resources can comprise various kinds of contact information for the authorized beneficiaries. This can include both two-way and one-way forms of communication and can further include, if desired, primary, secondary, and contingency mechanisms by which communications can occur. The processor can employ this information to not only determine how to contact a given authorized beneficiary in a given scenario, but also whether to effect other deployment options as a function, at least in part, of the availability of information regarding the integrity of such communication mechanisms. As one example in this regard, upon determining that cellular telephone service for a given area that services a given authorized beneficiary is impaired, the processor can provide for automatically facilitating the immediate (or at least urgent) delivery of civil security provisions to that authorized beneficiary which can include, in whole or in part, a communications device (such as a wireless satellite telephone, a two-way ham radio, a shortwave radio, or the like) that the authorized beneficiary can use when subsequently communicating with the provider of civil security benefits.

### EXAMPLE 24

As noted above, the information available to the processor can include information regarding the actual and/or projected behavior of persons within an area of projected, actual, or potential operation by personnel of the provider of civil security benefits. The processor can employ such information when making routing decisions regarding the delivery of civil security provisions, civil security services, and/or civil security facilities (such as a mobile civil security shelter) within or through such an area. By one approach the processor can be configured and arranged to identify paths of likely least resistance when suggesting or mandating such a route.

By another approach, if desired, such information can be employed to inform the deployment of particular kinds of vehicles, personnel, and/or equipment in a given instance as well as particular rules of engagement that are to be observed. For example, when determining that a particular civil security provisions delivery mission is likely to encounter large groups of lawless individuals who may be prone to attacking such a delivery vehicle, the processor can facilitate the use of delivery vehicles that are able to meet and surmount such a challenge (such as heavier, armored vehicles, escort security vehicles, and so forth), the use of at least some personnel who are trained and equipped with respect to crowd control and/or dispersement, the allocation of non-lethal and/or lethal weaponry, and so forth. Similarly, upon determining that a given delivery mission is not likely to encounter interaction with significant numbers of effective lawless individuals, the processor can arrange instead for the deployment of less formidable vehicles, personnel, and equipment. Again, such deployment decisions can greatly serve to make the optimum use of the provider's resources when seeking to meet the immediate and near term needs of a given population of authorized beneficiaries.

### EXAMPLE 25

The information available to the processor can also serve as a basis for facilitating an occasional or substantially on-going wargaming background or foreground task. Such wargaming processing can occur on a fully or partially automated basis or can be fully or partially informed and/or directed by one or more persons. By one approach, such wargaming can be based upon present information where particular threats are then posed and an ability of the provider of civil security benefits to respond in a satisfactory manner then extrapolated and estimated. The results of such wargaming activities can in turn be used strategically and/or tactically to better inform the short and long term preparations of the provider to meet the obligations of the aforementioned subscriptions.

### EXAMPLE 26

The information available to the processor may include content that suggests, either as a possibility or definitively, other persons with whom a given authorized beneficiary might presently (or later) be with or near. In such a case, such information could also be employed when making the above-described decisions regarding deployment of civil security resources. As one illustrative example in this regard, when a given authorized beneficiary has a subscription that provides for co-rescue of up to four other persons who might happen to be with that given authorized beneficiary at a time of rescue, and when information available to the processor suggests strongly that the authorized beneficiary is highly likely to be in the presence of only two other persons at the time of likely being rescued, the processor could specify that only rescue resources sufficient to rescue up to three persons be deployed in this particular regard notwithstanding that the authorized beneficiary's subscription provides for a greater number of rescuees. This, in turn, would free up other rescue resources for other necessary duties.

### EXAMPLE 27

As noted above, the information provided to the processor can vary over time. It is possible for such variations to occur with little or no advance notice and possibly in relatively large numbers. For example, by one approach access to one or more civil security resources may be permitted upon presentation by an authorized beneficiary of a corresponding bearer certificate (such as, but not limited to, a civil security benefits gift card or the like). This can occur when the provider of civil security benefits agrees, through whatever means one might wish to employ, to honor the presentation of such a bearer certificate with access to one or more general and/or specific civil security resources.

In many cases it may be difficult to predict with high accuracy where and when such bearer certificates will be presented for redemption. By providing the processor with redemption information, however, considerable improvement can be expected at least with respect to scheduling the re-provision of certain claim provisions or the like. It would also be possible to utilize such information to better predict particular locations where certain provisions, facilities, and/or services are likely to be needed. Such a determination could be based, for example, upon noting that a particular shelter was receiving bearer certificate-bearing authorized beneficiaries at twice the rate of other shelters within a given area in need. This, in turn, could be used to facilitate the automatic deployment of civil security mass transit (such as a bus, train, or the like) to move some of these authorized beneficiaries to other shelter locations where their needs can be properly met.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. An apparatus comprising:
a processor interface configured and arranged:
to provide access to a processor that is operably coupled via a memory interface to a memory having information stored therein regarding authorized beneficiaries of consideration-based private civil security subscriptions that provide civilly-catastrophic event-based access to at least one private civil security resource.

2. The apparatus of claim 1 wherein the processor interface is further configured and arranged to facilitate deployment of the at least one private civil security resource on behalf of at least one of the authorized beneficiaries in response to circumstances as correspond to a civilly-catastrophic event.

3. The apparatus of claim 2 wherein the information regarding the authorized beneficiaries comprises, at least in part, information regarding at least one of:
an authorized beneficiary's age;
an authorized beneficiary's gender;
an authorized beneficiary's physical status;
an authorized beneficiary's location;
an authorized beneficiary's relationship to other authorized beneficiaries;
an authorized beneficiary's predetermined civilly-catastrophic event response plan;
civil security provisions that are presently available locally to the authorized beneficiaries;
specific civil security resources to which specific authorized beneficiaries have a subscription-based right of access during a civilly-catastrophic event-based time of need;
transport modalities that are presently available locally to the authorized beneficiaries;
communication modalities that are presently available locally to the authorized beneficiaries;
civil security shelter facilities that are presently available locally to the authorized beneficiaries;
a current level of pre-provisioning of civil security provisions as are presently available to the authorized beneficiaries;
an authorized beneficiary's civil security resources preferences;
an authorized beneficiary's record of civil security related training;
an authorized beneficiary's record of civil security related experience;
an authorized beneficiary's specific civil security needs;
an assessment regarding the authorized beneficiary.

4. The apparatus of claim 2 wherein the information regarding the authorized beneficiaries comprises, at least in part, information regarding medical information regarding the authorized beneficiary.

5. The apparatus of claim 4 wherein the medical information regarding the authorized beneficiary comprises, at least in part, information regarding at least one of the authorized beneficiary's:
medical history;
physical impairments;
mental impairments;
mobility limitations;
mobility requirements;
therapeutic requirements;
medicinal requirements;
implanted medical devices;
allergies;
sensitivities;
personality assessments.

6. The apparatus of claim 2 wherein the at least one private civil security resource comprises, at least in part, at least one of:
civil security provisions;
civil security facilities;
civil security services.

7. The apparatus of claim 6 wherein the at least one private civil security resource comprises, at least in part, each of:
civil security provisions;
civil security facilities;
civil security services.

8. The apparatus of claim 6 wherein the civil security provisions comprise a plurality of life-sustaining resources as pertain to a plurality of differing categories of life's necessities.

9. The apparatus of claim 8 wherein the plurality of differing categories of life's necessities comprise:
breathable air;
water;
food; and
protective clothing.

10. The apparatus of claim 8 wherein the plurality of differing categories of life's necessities further comprises shelter.

11. The apparatus of claim 6 wherein the civil security facilities comprise a civil security shelter.

12. The apparatus of claim 11 wherein the civil security shelter comprises at least one of:
a temporary civil security shelter configured and arranged to adequately shelter and sustain human life for a relatively short period of time;
a long term civil security shelter configured and arranged to adequately shelter and sustain human life for a relatively long period of time.

13. The apparatus of claim 12 wherein the civil security shelter further comprises an indeterminate term civil security shelter configured and arranged to adequately shelter and sustain human life for an indeterminately long period of time.

14. The apparatus of claim 11 wherein the civil security shelter comprises a civil security shelter that is fractionally possessed, at least in part, by a plurality of different authorized beneficiaries.

15. The apparatus of claim 14 wherein the fractionally possessed civil security shelter comprises a substantially underground facility.

16. The apparatus of claim 6 wherein the civil security facilities comprise a rally point at which the authorized beneficiaries can gather in response to a civilly-catastrophic event in order to receive the civil security services.

17. The apparatus of claim 16 wherein the civil security services comprise transportation.

18. The apparatus of claim 17 wherein the transportation comprises at least one of:
transportation away from a location that substantially lacks civil security;
transportation to other of the civil security facilities.

19. The apparatus of claim 18 wherein the other of the civil security facilities comprise at least one of:
another of the rally points;
a civil security shelter;
a location where at least some of the authorized beneficiary's civil security provisions are available;
a trans-shipment facility for at least some of the civil security provisions;
a medical services facility.

20. The apparatus of claim 6 wherein the civil security services comprise:
transportation;
civil security information that is both generally and specifically appropriate for individual ones of the authorized beneficiaries;

21. The apparatus of claim 20 wherein the civil security information comprises contingency instructions to guide corresponding authorized beneficiaries during a time of need when responding to a civilly-catastrophic event.

22. The apparatus of claim 21 wherein the contingency instructions comprise personal contingency instructions that are specifically formed and provided to guide, specifically, specific corresponding authorized beneficiaries during a time of need regarding particular actions and behaviors that the authorized beneficiary should take and observe when responding to a civilly-catastrophic event.

23. The apparatus of claim 20 wherein the civil security services further comprise civil security preparedness training.

24. The apparatus of claim 6 wherein the civil security services comprise a long distance communications service that is configured and arranged to provide persistent communication services notwithstanding interaction of the long distance communication service with effects of a civilly-catastrophic event.

25. The apparatus of claim 6 wherein the civil security services comprise a rescue service to retrieve selected authorized beneficiaries from dangerous circumstances owing, at least in part, to a substantial lack of civil security.

26. The apparatus of claim 25 wherein the rescue service comprises, at least in part, rescuing authorized beneficiaries who are located within rescue capsules.

27. The apparatus of claim 26 wherein rescuing authorized beneficiaries who are located within rescue capsules comprises, at least in part, airlifting the rescue capsules from atop buildings.

28. The apparatus of claim 25 wherein the dangerous circumstances comprise likely dangerous circumstances that are owing, at least in part, to an imminent likely substantial lack of civil security.

29. The apparatus of claim 6 wherein the civil security services comprise an information system that an authorized beneficiary can access to receive substantially real-time advice regarding near-term actions to take with respect to a given civilly-catastrophic event.

30. The apparatus of claim 6 wherein the civil security services comprise at least one of:
delivery of at least a portion of the civil security provisions;
transport of dispossessed persons;
physical security;
medical services;
post-civilly-catastrophic event social relationship facilitation;
delivery of fuel;
installation of independent utilities facilities.

31. The apparatus of claim 2 wherein the private civil security subscriptions that provide civilly-catastrophic event-based access to at least one private civil security resource comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access.

32. The apparatus of claim 2 wherein the civilly-catastrophic event comprises at least one of:
a natural disaster;
a non-naturally-caused disaster.

33. The apparatus of claim 2 wherein the memory interface is configured and arranged to provide the access to the memory even when the memory is geographically substantially distal to the processor.

34. The apparatus of claim 2 wherein the processor is further configured and arranged to facilitate deployment of the at least one private civil security resource on behalf of at least one of the authorized beneficiaries in response to circumstances as correspond to a civilly-catastrophic event as a function, at least in part, of the information stored in the memory regarding the authorized beneficiaries.

35. The apparatus of claim 34 wherein the processor is further configured and arranged to facilitate deployment of the at least one private civil security resource on behalf of at least one of the authorized beneficiaries in response to circumstances as correspond to a civilly-catastrophic event as a function, at least in part, of information regarding the civilly-catastrophic event.

36. The apparatus of claim 35 wherein the information regarding the civilly-catastrophic event comprises information regarding a likelihood of at least one of:
the civilly-catastrophic event occurring;
the civilly-catastrophic event persisting for at least a predetermined amount of time;
the civilly-catastrophic event occurring with respect to a particular geographic locale;
the civilly-catastrophic event exhibiting at least a particular level of impact with respect to corresponding civil infrastructure.

37. The apparatus of claim 35 wherein the information regarding the civilly-catastrophic event comprises, at least in part, a classification of the civilly-catastrophic event with respect to at least one of a:
category of civilly-catastrophic event;
kind of civilly-catastrophic event;
magnitude of civilly-catastrophic event.

38. The apparatus of claim 35 wherein the information regarding the civilly-catastrophic event comprises, at least in part, classification of the civilly-catastrophic event with respect to at least a four level classification system.

39. The apparatus of claim 38 wherein the four level classification system comprises a four level classification that is at least substantially maintained by a provider of the private civil security resources.

40. The apparatus of claim 38 wherein the processor is further configured and arranged to facilitate deployment of the at least one private civil security resource on behalf of a particular authorized beneficiary by:
when the civilly-catastrophic event comprises a first level civilly-catastrophic event, waiting for the particular authorized beneficiary to proactively signal a need for making access to the private civil security resources without taking other significant preparatory private civil security resources deployment actions;
when the civilly-catastrophic event comprises a second level civilly-catastrophic event, waiting for the particular authorized beneficiary to proactively signal a need for making access to the private civil security resources while also taking at least one significant preparatory private civil security resources deployment action;
when the civilly-catastrophic event comprises a third level civilly-catastrophic event, initiating an attempt to contact the particular authorized beneficiary to determine whether access to the civil security resources should be effected and, upon failing in this attempt, automatically taking steps to proactively provide the particular authorized beneficiary with access to the civil security resources;
when the civilly-catastrophic event comprises a fourth level civilly-catastrophic event, automatically taking steps to proactively provide the particular authorized beneficiary with access to the civil security resources even in the absence of a proactive signal from the particular authorized beneficiary of a need for such access and in the absence of initiating an attempt to contact the particular authorized beneficiary to determine whether access to the civil security resources should be effected.

41. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a characterizing nature of the civilly-catastrophic event itself.

42. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a geographic location of an area that is at least likely to be impacted by the civilly-catastrophic event.

43. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of terrain of an area that is at least likely to be impacted by the civilly-catastrophic event.

44. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of applicable information regarding the particular authorized beneficiary.

45. The apparatus of claim 44 wherein the applicable information comprises, at least in part, the information stored in the memory regarding the particular authorized beneficiary.

46. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, a likely number of persons to be substantially directly affected by the civilly-catastrophic event.

47. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a corresponding season as pertains to an area that is at least likely to be impacted by the civilly-catastrophic event.

48. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of weather as pertains to an area that is at least likely to be impacted by the civilly-catastrophic event.

49. The apparatus of claim 48 wherein the weather comprises, at least in part, presently occurring weather.

50. The apparatus of claim 48 wherein the weather comprises, at least in part, forecast weather.

51. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of prevailing ambient lighting as pertains to an area that is at least likely to be impacted by the civilly-catastrophic event.

52. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a particular weekly day as pertains to an area that is at least likely to be impacted by the civilly-catastrophic event.

53. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a particular time of day as pertains to an area that is at least likely to be impacted by the civilly-catastrophic event.

54. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of potential obstacles to civil security resources service providers as pertains to an area that is at least likely to be impacted by the civilly-catastrophic event.

55. The apparatus of claim 54 wherein the potential obstacles comprise at least one of:
vehicular obstacles;
flooded conditions;
a substantial lack of civil order;
terrain-based obstacles;
visual impairment-based obstacles;
dangerous air-borne contaminants;
a zone of dangerous ionizing radiation.

56. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of residual threats to civil security resources service providers as pertains to an area that is at least likely to be impacted by the civilly-catastrophic event.

57. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of an ability to communicate with the particular authorized beneficiary notwithstanding the civilly-catastrophic event.

58. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of a likely duration of a debilitating influence of the civilly-catastrophic event.

59. The apparatus of claim 2 wherein the processor is further configured and arranged to facilitate deployment of the at least one private civil security resource on behalf of a particular authorized beneficiary in response to circumstances as correspond to a civilly-catastrophic event as a function, at least in part, of each of:
a characterizing nature of the civilly-catastrophic event itself;
a geographic location of an area that is at least likely to be impacted by the civilly-catastrophic event;
terrain of an area that is at least likely to be impacted by the civilly-catastrophic event;
applicable information regarding the particular authorized beneficiary;
a likely number of persons to be substantially directly affected by the civilly-catastrophic event;
a corresponding season as pertains to an area that is at least likely to be impacted by the civilly-catastrophic event;
weather as pertains to an area that is at least likely to be impacted by the civilly-catastrophic event;
prevailing ambient lighting as pertains to an area that is at least likely to be impacted by the civilly-catastrophic event;
a particular weekly day as pertains to an area that is at least likely to be impacted by the civilly-catastrophic event;
a particular time of day as pertains to an area that is at least likely to be impacted by the civilly-catastrophic event;
potential obstacles to civil security resources service providers as pertains to an area that is at least likely to be impacted by the civilly-catastrophic event;
residual threats to civil security resources service providers as pertains to an area that is at least likely to be impacted by the civilly-catastrophic event;
an ability to communicate with the particular authorized beneficiary notwithstanding the civilly-catastrophic event;
a likely duration of a debilitating influence of the civilly-catastrophic event.

60. The apparatus of claim 2 wherein the processor interface comprises, at least in part, a display.

61. The apparatus of claim 60 wherein the display is located at a private civil security facility that comprises one of the private civil security resources.

62. The apparatus of claim 60 wherein the display is configured and arranged to display information as provided by the processor regarding deployment of the private civil security resources when responding to needs stemming from the civilly-catastrophic event.

63. The apparatus of claim 62 wherein the information as provided by the processor comprises, at least in part, a recommendation.

64. The apparatus of claim 62 wherein the information as provided by the processor comprises, at least in part, an order.

65. The apparatus of claim 62 wherein the information as provided by the processor comprises, at least in part, information regarding actions to take with respect to at least one of a civil security provision, a civil security facility, and a civil security service.

66. The apparatus of claim 2 wherein the processor is further configured and arranged to facilitate the maintaining the at least one private civil security resource.

67. The apparatus of claim 66 wherein maintaining the at least one private civil security resource comprises, at least in part, providing scheduled maintenance information via the processor interface.

68. The apparatus of claim 2 wherein the processor interface is further configured and arranged to provide access to a second processor that serves as a redundant resource for the processor.

69. The apparatus of claim 2 wherein the processor interface is further configured and arranged to facilitate deployment of the at least one private civil security resource on behalf of a plurality of the authorized beneficiaries in response to circumstances as correspond to each of a plurality of overlapping different civilly-catastrophic events.

70. The apparatus of claim 2 wherein at least some of the consideration-based private civil security subscriptions have a corresponding amount of consideration that is based, for given ones of the authorized beneficiaries, at least in part, on the information as corresponds to the given ones of the authorized beneficiaries.

71. The apparatus of claim 70 wherein the information as corresponds to the given ones of the authorized beneficiaries comprises information that tends to suggest how such individuals will behave during a civilly-catastrophic event.

72. The apparatus of claim 71 wherein the information that tends to suggest how such individuals will behave during a civilly-catastrophic event comprises information that tends to suggest how such individuals will behave with respect to at least one of:
a civil security shelter environment;
civil security transportation;
participation in a civil security rescue activity;
civil security-related tasks;
cooperation with others in a civil security activity.

73. The apparatus of claim 2 wherein the information comprises information regarding a given authorized beneficiary's right to optionally purchase emergency supplies via their corresponding consideration-based private civil security subscription.

74. The apparatus of claim 73 wherein the right to optionally purchase emergency supplies comprises, at least in part, a right to optionally purchase emergency supplies at no more than a given price.

75. The apparatus of claim 73 wherein the right to optionally purchase emergency supplies is conditioned, at least in part, upon a recognized civilly-catastrophic event being at least imminently likely.

76. The apparatus of claim 2 wherein the processor is configured and arranged to use the information regarding the authorized beneficiaries to facilitate remuneration of third party agents who sold the consideration-based private civil security subscriptions.

77. The apparatus of claim 2 wherein the information comprises, at least in part, loyalty rewards information as pertains such the authorized beneficiaries.

78. The apparatus of claim 77 wherein the processor is configured and arranged to facilitate deployment of the at least one private civil security resource as a function, at least in part, of the loyalty rewards information.

79. A method comprising:
prior to an occurrence of an applicable civilly-catastrophic event:
providing a memory having information stored therein regarding authorized beneficiaries of consideration-based private civil security subscriptions that provide civilly-catastrophic event-based access to at least one private civil security resource;
providing a processor interface;
providing a processor that is operably coupled to the memory and to the processor interface to facilitate deployment of the at least one private civil security resource on behalf of at least one of the authorized beneficiaries in response to circumstances as correspond to a civilly-catastrophic event.

80. The method of claim 79 further comprising:
upon detecting a need to respond to a civilly-catastrophic event:
using the information regarding the authorized beneficiaries to facilitate deployment of the at least one private civil security resource on behalf of the at least one of the authorized beneficiaries in response to circumstances as correspond to the civilly-catastrophic event.

81. The method of claim 80 wherein facilitating deployment of the at least one private civil security resource comprises at least one of:
selecting a particular authorized beneficiary contact protocol from a plurality of candidate authorized beneficiary contact protocols to employ with respect to deploying the at least one private civil security resource.

82. The method of claim 81 wherein selecting a particular authorized beneficiary contact protocol from a plurality of candidate authorized beneficiary contact protocols comprises selecting the particular authorized beneficiary contact as a function, at least in part, of a characterizing aspect of the civilly-catastrophic event.

83. The method of claim 80 further comprising facilitating deployment of the at least one private civil security resource as a function, at least in part, of at least one of:
a characterizing nature of the civilly-catastrophic event itself;
a geographic location of an area that is at least likely to be impacted by the civilly-catastrophic event;
terrain of an area that is at least likely to be impacted by the civilly-catastrophic event;
applicable information regarding the particular authorized beneficiary;
a likely number of persons to be substantially directly affected by the civilly-catastrophic event;
a corresponding season as pertains to an area that is at least likely to be impacted by the civilly-catastrophic event;
weather as pertains to an area that is at least likely to be impacted by the civilly-catastrophic event;
prevailing ambient lighting as pertains to an area that is at least likely to be impacted by the civilly-catastrophic event;
a particular weekly day as pertains to an area that is at least likely to be impacted by the civilly-catastrophic event;
a particular time of day as pertains to an area that is at least likely to be impacted by the civilly-catastrophic event;
potential obstacles to civil security resources service providers as pertains to an area that is at least likely to be impacted by the civilly-catastrophic event;
residual threats to civil security resources service providers as pertains to an area that is at least likely to be impacted by the civilly-catastrophic event;
an ability to communicate with the particular authorized beneficiary notwithstanding the civilly-catastrophic event;
a likely duration of a debilitating influence of the civilly-catastrophic event.
